(19) United States
(12) Patent Application Publication
(10) Pub. No.: US 2011/0229321 A1
(43) Pub. Date: Sep. 22, 2011

(54) VORTEX DYNAMICS TURBINE

(75) Inventor: Michael Stavrou Kilaras, Nicosia (CY)

(73) Assignee: AEROVORTEX MILLS LTD, Nicosia (CY)

(21) Appl. No.: 13/132,279

(22) PCT Filed: Nov. 23, 2009
(86) PCT No.: PCT/EP2009/065633

§ 371 Date: Jun. 1, 2011

(30) Foreign Application Priority Data
Dec. 2, 2008 (GB) 0821965.1

(51) Int. Cl. F03D 11/02; F16L 41/00

(52) U.S. Cl. 416/1; 137/561 A; 416/241 R

(57) ABSTRACT

The invention relates to the use of Air and Hydro Turbines for power generation. It seeks to enhance the energy-capturing potential of air/water turbines, and hence expand the geography where they can be used. It is mainly represented by a device consisting of a vortex generator and a vortex accelerator. This vorticity device operates in a combination of 2 modes: (1) Control airfoil circulation at the blade tips and hence control or alleviate the aerodynamic loading on the turbine blades. (2) Induce suction that can be used to transfer momentum to the flow close to the surface of the blade. Specifically, the generated suction drives secondary fluid flow, which is used to enhance the aerodynamic characteristics of the turbine blades/wings, by doing the following: (1) Suppressing adverse pressure gradients, (2) Suppressing the stall or separation bubble, (3) Laminarize the flow over the blade or wing.

### BACKGROUND OF THE INVENTION

The invention relates to the use of Wind and Aero Turbines as well as Underwater or Hydro Turbines and Oscillating Wing applications. The design principles of the described mechanism, apply to any aerodynamic or hydrodynamic surface, such as a wing, empennage, flap, propeller blade and fan blade.

Specifically, the invention pertains to the active and/or passive control of the flow circulation around an airfoil as well as the momentum transfer to the flow close to the lifting surface, in order to enhance its aerodynamic/hydrodynamic characteristics.

In the past, various mechanisms have been tested for improving and/or controlling the aerodynamic characteristics of an airfoil. Active Flow Control (AFC) which can be distinguished into Boundary Layer Suction (BLS) and Surface Blowing, air-jet vortex generators, gurney flaps and normal flaps, all have been successfully tested in a lot of airfoil applications, primarily in the aerospace industry. The results show very promising aerodynamic performance improvement with drag reduction up to 60% and Lift-to-Drag ratio (L/D) increase up to 20%. Recently, a company named Aerolaminates Ltd in cooperation with City University in the UK, under an EU-funded project, investigated the effects of using air-jet vortex generators in large wind turbine blades. The results of this investigation show an estimated improvement in energy yield of 8% over the baseline turbine, a NEG Micon 1.5 MW stall-regulated turbine. Despite their promising test results, all of the above-mentioned techniques, incur a high drag penalty or add weight and complexity which increase the Cost of Energy (COE) disproportionately to their performance improvement contribution.

Wind Turbine manufacturers are currently developing low wind technologies in an effort to lower the Cost of Energy (COE) and improve the competitiveness of wind energy in order to facilitate the expansion of wind development in low wind and offshore sites. The new technology under development is primarily focused in two directions: (1) Increase the turbine tower height and (2) Increase the rotor diameter. These two ideas increase the energy-capturing potential of wind turbines by exposing the turbine rotor to more incoming flow and of higher energy content or higher flow speed. However, their eventual commercialization depends on successfully overcoming a number of challenging technical hurdles which relate to their added weight, complexity and cost as well as the safe deployment of wind turbines in low wind areas with extreme wind gusts and turbulence.

As far as underwater turbines are concerned, they can be used to harness the energy of tidal or underwater currents. Most of these turbines, currently under consideration, are horizontal-axis and their technology derives heavily from wind turbines. Water is 850 times denser than air, and as a result an underwater turbine can generate more energy than a much larger in diameter wind turbine. Beyond this detail, water is a fluid like wind or air and hence the design principles of an underwater turbine are similar to those of a wind turbine.

### BRIEF SUMMARY OF THE INVENTION

The present invention is a device which consists of a vortex generator combined with a vortex accelerator that intercepts or compresses the generated vortical flow. The use of the fore mentioned device on the airfoil surface, preferably on its high pressure surface or side, generates vorticity which can be used to transfer momentum to the surface flow in a way that enhances the aerodynamic characteristics by suppressing adverse pressure gradients. Also, the compression of the generated vorticity by an active/passive vortex accelerator surface protrusion on either the low or high pressure blade surface, constitutes a simple, low cost, fast response and highly effective method for controlling enhanced airfoil circulation. Additionally, the use of the vortex accelerator for capturing the generated vorticity, reduces the drag penalty associated with the vortex generator.

By way of example, and not a limitation, a plurality of the above mentioned vorticity devices (vortex generator coupled with a vortex accelerator) are installed on the high pressure or impact surface of each blade of a wind or underwater turbine. Preferably, these devices are mounted close to the trailing edge of each blade, which can be either sharp or blunt. The generation and control of vorticity by the proposed devices, gives rise to localized surface pressure drop or suction, which can be used through the use of surface slots/holes connected to conduits inside the blade, to suck slow moving flow close to the blade surface and hence help laminarize the flow or delay or even prevent flow separation on the blade surface. The improvement of the aerodynamic characteristics using suction to suppress adverse pressure gradients might be preferable to take place at the blade tips which are more effective in generating power output. This does not exclude the use of the invention devices in parts of the blades other than the tips. Also in a different embodiment, the use of these vorticity devices (Vortex Generator coupled with a Vortex Accelerator) at the blade tip for controlling circulation and hence the aerodynamic loading, can be proven especially beneficial in the deployment of light weight and longer blades which can safely operate in extreme wind gust and turbulent conditions. Basically, the vorticity generation by the vortex generator and its capture by the vortex accelerator can be used for enhancing or controlling circulation around the turbine blade airfoil sections. Ultimately, this circulation control can be used to control or reduce extreme aerodynamic loads on the blades.

The installation of the invention devices on turbine blades, will help lower the Cost of Energy (COE) by increasing the energy-capturing potential of wind turbines and hence facilitate the expansion of the geography where wind turbines can be used. The performance improvement that can be achieved by the invention is not merely related to the enhancement of the turbine blade aerodynamics, but it can also be proved important in solving technical hurdles challenging the development of new low wind technologies like higher towers and especially longer rotor blades. The simplicity and low cost of the proposed devices will ensure their wide adoption by installing them to new turbine rotor blades and/or integrating them in existing turbine rotor blades. A detailed description of the invention is given in the sections that follow. The purpose of this description is to fully disclose its preferred embodiments without placing limitations thereon.

The invention will now be described with reference to the accompanying drawings.

### BRIEF DESCRIPTION OF THE DRAWINGS

FIG. 1 is a schematic view of a three-blade turbine with the variant 1 of vorticity-induced suction devices attached on the high pressure surface of the blades, and suction holes on the low-pressure surface of the blade at the tip;

FIG. 2 is a schematic close-up view of the variant 1 suction devices on the high pressure surface of the three-blade turbine;

FIG. 3 is a schematic view from the rear of a three-blade turbine, showing the suction holes at the tip of the low-pressure surface of a blade and the variant 1 of vorticity-induced suction devices on the high pressure surface of another blade;

FIG. 4 is a close-up view of the suction holes on the low pressure surface at the tip of a turbine blade;

FIG. 5 A view of a turbine blade section, seen directly from behind the trailing edge, that shows variant 1 vorticity-induced suction devices on the high pressure surface of the blade (top) and suction holes on the low-pressure surface of the blade (bottom);

FIG. 6 Schematic close-up view of the high pressure surface of a turbine blade, fitted with the variant 1 of vorticity-induced suction devices;

FIG. 7 Schematic close-up view of the high pressure surface of a section of a turbine blade, fitted with the variant 1 of vorticity-induced suction devices;

FIG. 8A/B Schematic view of two sections of a turbine blade, fitted with two pairs of vorticity-induced suction devices attached to the high-pressure surface of the blade. Inside view from the side, of the low-pressure surface of the blade where suction holes exist;

FIG. 8C Schematic view of a section of a turbine blade showing the low-pressure surface with suction holes;

FIG. 9 is a cross section view of the turbine blade fitted with vorticity-induced suction devices on its high pressure surface and suction holes on its low pressure surface at the tip;

FIG. 10 is variant 2 of the vorticity-induced suction device which can be installed on the high pressure surface of a turbine blade in a similar way as variant 1 shown in FIGS. 1 to 9;

FIG. 11 Top, Side and Rear view diagrams of the variant 2 vorticity-induced suction device shown in FIG. 10;

FIG. 12A/B Variant 3 vorticity-induced suction device with a trapezoidal flap as vortex generator and triangular inclined surfaces or protrusions as vortex accelerators;

FIG. 12C/D Variant 3 vorticity-induced suction device with a groove under the trapezoidal vortex generator;

FIG. 13 Top, Side and Rear view diagrams of variant 4 of the vorticity-induced suction device which can be installed on the high pressure surface of a turbine blade in a similar way as variant 1 shown in FIGS. 1 to 9;

FIG. 14 Top, Side and Rear view diagrams of variant 5 of the 25 vorticity-induced suction device which can be installed on the high pressure surface of a turbine blade in a similar way as variant 1 shown in FIGS. 1 to 9;

FIG. 15 Variant 6 vorticity-induced suction devices in the form of grooves, installed on the high pressure surface of the turbine blade. Top and cross-section view of the blade fitted with this variant of the device;

FIG. 16A Variant 7 vorticity-induced suction devices in the form of triangular grooves, installed on the high pressure surface of the turbine blade along the trailing edge;

FIG. 16B Variant 7 vorticity-induced suction devices in the form of triangular grooves, installed on the high pressure surface of the turbine blade along its trailing edge. Flaps are used as vortex accelerators;

FIG. 17 Variant 8 vorticity-induced suction devices in the form of triangular grooves with step long edges;

FIG. 18 Variant 9 vorticity-induced suction devices in the form of triangular grooves with step long edges;

FIG. 19A Variant 10 vorticity-induced suction device that consists of a serrated flap along the trailing edge of the high-pressure blade surface and a regular flap along the trailing edge of the low pressure surface;

FIG. 19B Cross section of a blade fitted with the variant 10 vorticity-induced suction device, shown in FIG. 19A;

FIG. 20 Variant 11 vorticity-induced suction device that consists of a serrated flap as a multiple vortex generator and triangular flaps as vortex accelerators. All flaps are attached on the high pressure surface of the blade;

FIG. 21 Variant 12 vorticity-induced suction device that consists of a serrated flap as a multiple vortex generator and a regular flap downstream as a vortex accelerator. All flaps are attached on the high pressure surface of the blade;

FIG. 22A is variant 13 of the vorticity-induced suction device which can be installed on the high pressure surface of a turbine blade in a similar way as variant 1 shown in FIGS. 1 to 9; This variant can also be used for controlling circulation. More versions of this variant shown in FIGS. 44-45.

FIG. 22B shows one possible side view and corresponding top view configurations for the variant 13 of the vorticity-induced suction device displayed in FIG. 22A;

FIG. 22C shows another possible side view and corresponding top view configurations for the variant 13 of the vorticity-induced suction device displayed in FIG. 22A;

FIG. 23A is variant 14 of the vorticity-induced suction device which can be installed on the high pressure surface of a turbine blade in a similar way as variant 1 shown in FIGS. 1 to 9;

FIG. 23B shows one possible side view and corresponding top view configurations for the variant 14 of the vorticity-induced suction device displayed in FIG. 23A;

FIG. 23C shows one possible side view for the variant 14 of the vorticity-induced suction device displayed in FIG. 23A;

FIG. 24 is variant 15 of the vorticity-induced suction device with a pair of triangular vortex generators and a half conical vortex accelerator. It can be installed on the high pressure surface of a turbine blade in a similar way as variant 1 shown in FIGS. 1 to 9;

FIG. 25 shows one pair of variant 16 vorticity-induced suction devices. Each device consists of two triangular surfaces: one vortex generator and one vortex accelerator with suction holes between them, on the blade surface;

FIG. 26 shows views of variant 17 of vorticity-induced suction device. It has two leading triangular surfaces as vortex generator and a trailing pyramidal protrusion as vortex accelerator with suction holes on it;

FIG. 27 is variant 18 of vorticity-induced suction device in the form of a vortex chamber embedded in the high pressure surface of the blade;

FIG. 28: Variant 19 of Vorticity-Induced Pressure Differential Surface Device similar to variant 1 shown in FIGS. 1 through 9. In this variant, the vortex generator is a triangular blade surface skin protrusion with a groove underneath; and

FIG. 29: Variant 19 of Vorticity-induced devices attached to the high pressure surface of a turbine blade.

FIG. 30: Variant 20 of Vorticity-induced device, shown with the generated vortex. The vortex generator of the device consists of a half span delta wing or triangular flat surface attached to the surface of a turbine blade. The vortex accelerator, behind the vortex generator, consists of a wedge-shaped protrusion. Details of this variant shown in figures that follow, and more variant configurations shown in FIGS. 42-43.

FIG. 31: A series of Variant 20 Vorticity-induced devices attached to the low pressure surface at the trailing edge of a turbine blade.

FIG. 32A: A turbine blade section indicating the position where the Variant 20 Vorticity-induced device can be installed.

FIG. 32B: Variant 20 Vorticity-induced device fully retracted in the turbine blade trailing edge.

FIG. 32C: Variant 20 Vorticity-induced device extended from the blade surface at the trailing edge.

FIG. 33A/B/C: Variant 20 Vorticity-induced device in 3 different configurations where the vortex accelerator is installed at 3 different positions or distances from the vortex generator.

FIG. 34A/B/C: Variant 20 Vorticity-induced device with 3 different versions of its vortex accelerator. In 34A, the vortex accelerator has only 1 triangular surface perpendicular to the blade surface. In 34B, the vortex accelerator has 2 triangular surfaces perpendicular to the blade surface. In 34C, the vortex accelerator consists only of an inclined triangular surface to the blade surface.

FIG. 35A/B/C: An alternative side view for the variant 20 Vorticity-induced device configurations shown in FIGS. 34A/B/C.

FIG. 36A/B/C: Variant 20 Vorticity-induced device configurations shown in previous FIGS. 35A/B/C, depicted with the generated vortex.

FIG. 37 (A) Wedge-shaped vortex accelerator fully extended, (B) Wedge-shaped vortex accelerator half extended, and (C) Wedge-shaped vortex accelerator fully retracted.

FIG. 38 (A) Vortex generator fully extended, (B) Vortex generator half extended, and (C) Vortex generator fully retracted.

FIG. 39A: Side view of a fully extended vortex generator perpendicular to the blade surface. Also shown, the retraction groove inside the blade.

FIG. 39B: Side view of a fully extended vortex generator inclined to the blade surface. Also shown, the retraction groove inside the blade.

FIG. 40A: Top view of variant 13 Vorticity-induced device, also shown in FIGS. 22A/B/C.

FIG. 40B/C: Top views of 2 configurations for the variant 20 Vorticity-induced device. The devices feature suction holes.

FIG. 41A/B/C: 3-D renderings of variant 20 Vorticity-induced device, also shown in FIG. 34C. This version's vortex accelerator is a triangular surface inclined to the blade surface.

FIG. 42A/B/C/D: 3-D renderings of variant 20 Vorticity-induced device, also shown in FIGS. 30-36. The vortex accelerator of this version has 2 triangular surfaces perpendicular to the blade surface or is a wedged protrusion to the surface.

FIG. 43A/B/C: 2-D top views of variant 20 Vorticity-induced device, shown in FIG. 41-42.

FIG. 44A/B/C: 3-D and 2-D renderings of variant 13 (FIG. 22) Vorticity-induced device in an “X” configuration.

FIG. 45A/B/C: 3-D and 2-D renderings of variant 13 (FIG. 22) Vorticity-induced device in an “Sequential Arrow” configuration.

### DETAILED DESCRIPTION OF THE PREFERRED VARIANTS

Although the preferred variants or embodiments of the present invention are described hereinafter with reference to a wind turbine blade or airfoil, the principles apply to any aerodynamic or hydrodynamic lifting surface, such as a wing, empennage, flap, propeller blade, fan blade etc.

The invention seeks to enhance the energy-capturing potential of wind turbines in order to make them cost-effective in low-wind areas and hence expand the geography where wind turbines can be used. The ultimate goal is to improve the competitiveness of low-wind as well as offshore sites making them more attractive for wind development well into the future. As far as underwater turbines are concerned, the invention seeks to improve their output performance which will eventually help render them economically viable for wide use. Specifically, the invention aims to achieve the following technical goals for both wind/air and underwater/hydro turbines:
(1) The part of the rotor blades at the tips is the most effective in harnessing the incoming energy of the flow, for both wind and hydro turbines. For example, about ⅔ of the power output of horizontal axis wind turbines comes from ⅓ of the blades at their tips. For this reason, the invention seeks to efficiently harness the incoming energy of the flow at and/or around the rotor hub and redirect the energy that would otherwise be spilled or lost in the near wake of the rotor blades to the tips. This way, this energy can be used to enhance the aero/hydrodynamic characteristics of the blade tips and hence render them a lot more effective in harnessing the energy in the incoming flow for generating power output.
(2) Modify or enhance the flow circulation around the blade airfoil, in a way that augments the L/D ratio and hence improve the energy-capturing potential of the turbine.
(3) Control the generated circulation around the blade airfoil, in such a way that the invention alleviates extreme dynamic loading on the blades during wind gusts or generally rapidly changing flow speeds. The above-mentioned flow circulation control can be more effective in reducing extreme aerodynamic loading on the blades, when applied at the blade tips.
(4) The reduction of extreme dynamic loads and hence fatigue on the rotor blades, will facilitate the use of lighter and longer blades which are both less costly (cost is proportional to the 3^{rd} power of blade weight) and can capture more of the incoming flow energy.
(5) Generate vorticity on the impact or high pressure surface of the turbine blades or airfoils and make use of this vorticity in order to efficiently transfer momentum to the low pressure surface of the blades. This momentum transfer is used to suppress adverse pressure gradients on the low pressure surface of the blades and hence prevent or delay transition to turbulence and/or suppress flow separation. Effectively, the kinetic energy of the incoming flow is efficiently converted to a pressure differential energy across the high/low pressure surfaces of the rotor blades, using the artificially-generated vorticity on the high pressure blade surface. This enhanced pressure differential as a result of improving the aerodynamic characteristics of the blades (augment L/D), substantially contributes to the increase of the energy-capturing capability of the turbine.
(6) By improving the energy-capturing potential of wind turbines, the invention aims to make wind turbines economically viable in low-wind and offshore areas without or with limited increase in rotor blade length. Given the fact that the weight of the rotor blades increases with the 3rd power of their length, by increasing the power output performance with limited or no increase in rotor diameter, the weight of the turbine and hence its cost, are both kept low and competitive.
(7) By enhancing the aerodynamic characteristics of the blades, the invention seeks to increase the “pulling” or “pushing” loading on the blades, and hence be able to use a “heavier” generator of higher capacity in low winds. In other words, the aerodynamic enhancement of the rotor blades, increases the optimum specific rating (Power/Area) of wind turbines across all wind regimes, and especially those with low average winds. This will help increase the overall aggregate power output of the turbine over time and also make low-wind efficiencies similar to those in high-wind conditions. As a result, a low-wind turbine will be able to harness the energy from the frequent low winds the same effectively as when rare high winds occur with a lot more energy content.
(8) The invention also seeks to reduce the emitted noise from the wind turbines, by reducing the generated wake behind the fast-moving rotor blade tips.
(9) The invention will help improve the output performance of underwater or hydro turbines and hence render them cost effective for commercial use.
(10) The invention will help prevent the underwater turbines from stalling during changing underwater or tidal currents.

The invention seeks to achieve the above-mentioned technical milestones or improvements for wind/hydro turbines by using the thrust-generating principles of capturing the energy from body-bound or external fluid vorticity, deployed in fish locomotion or bird/insect flight propulsion.

Specifically, vortex generators of various forms are coupled with downstream vortex accelerators, which are basically surfaces or flaps or protrusions used for compressing the generated vortex flow. Both of the fore-mentioned elements, the vortex generator and the vortex accelerator, can be static or translational or rotational and function passively and/or actively. The vortex generator and the vortex accelerator constitute a mechanism. The operation of this mechanism can be distinguished to two different modes, each of which can be used to change the aerodynamic characteristics of the turbine blades or wings and hence their aerodynamic/hydrodynamic loading, by changing the flow over them. Both of the fore-mentioned modes of operation can be used either separately or in combination in order to achieve the desired aerodynamic/hydrodynamic effect. These two modes of operation are the following:
(1) Mode 1: The vorticity generation by the vortex generator (VG) and its active and/or passive compression by the vortex accelerator (VA) of each of the fore-mentioned mechanisms, that preferably takes place in the trailing-edge region of the airfoil, on either the low or the high pressure surface, is used to modify the circulation around the airfoil by effectively changing the Kutta condition at the trailing edge. Ultimately, the aerodynamic characteristics of the airfoil are affected.
(2) Mode 2: The use of the vortex accelerator to compress the generated vorticity results in the creation of a suction effect, which can be used to transfer momentum to either the low pressure surface of the turbine blade, or even the high pressure surface of the blade, in order to change its aerodynamic characteristics and hence its loading and ultimately the power output of the wind turbine.

Both constituent elements of the described mechanism, the vortex generator and the vortex accelerator, each can have any form, shape and size that optimizes its performance. This applies in either mode of operation: mode 1 or mode 2. In one embodiment, either element of the mechanism, the vortex generator or the vortex accelerator, is a flat surface of triangular or rectangular shape, that when deployed outwards, it extends normally to the surface. In another embodiment, each element is also a flat surface and extends or retracts at an angle other than the normal to the surface. Both elements of the mechanism, in all of their electromechanically actuated embodiments, can either fully retract inside the airfoil, or extend several millimetres or centimetres above the surface, this extension distance being a fraction or a multiple of the boundary layer thickness.

In some of their embodiments, the vortex generator and/or the vortex accelerator can be hinged on the surface. When they are actively actuated, instead of translating to retract or extend, their deployment outwards or inwards the airfoil takes place by means of rotation around a hinge.

The fore-mentioned elements of the mechanism, the vortex generator and the vortex accelerator, in some embodiments they are statically installed and in other embodiments they are actively actuated on the surface forward a sharp or tapered trailing edge of the airfoil. Also, the same mechanism, can be mounted, operating passively (statically installed) or actively (actuated) forward a blunt trailing edge of the airfoil.

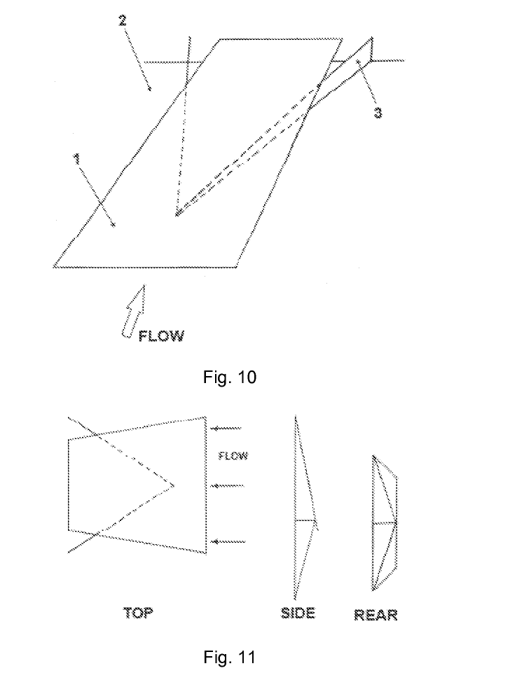

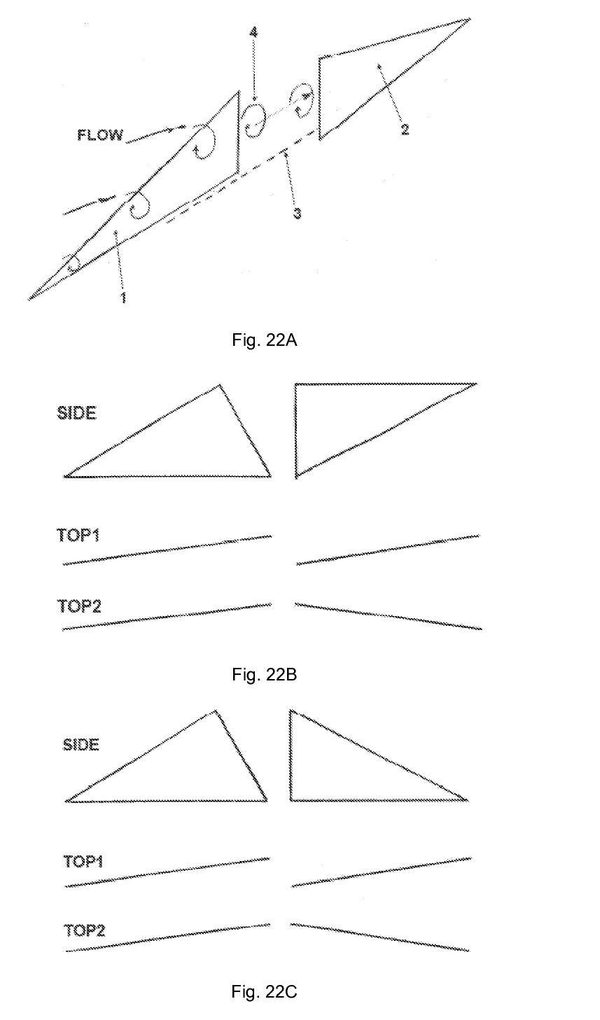

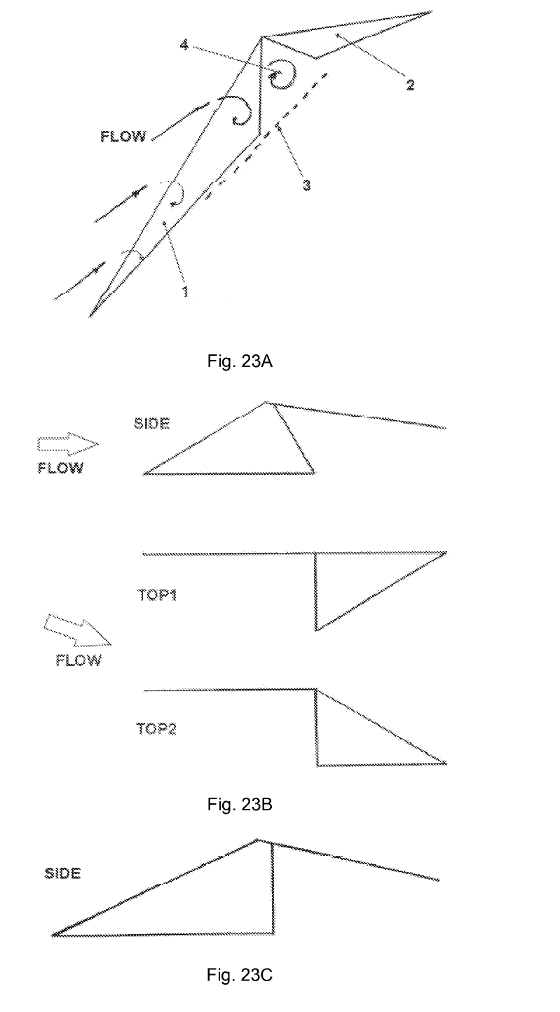

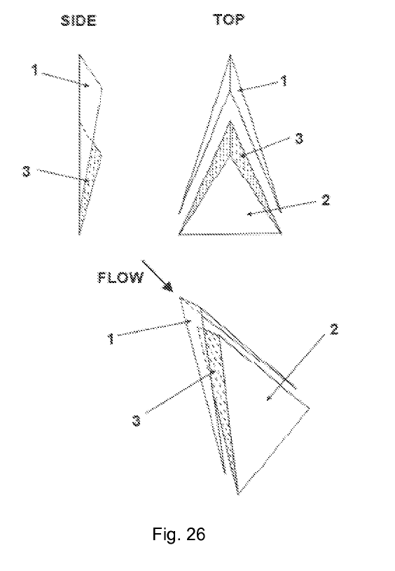

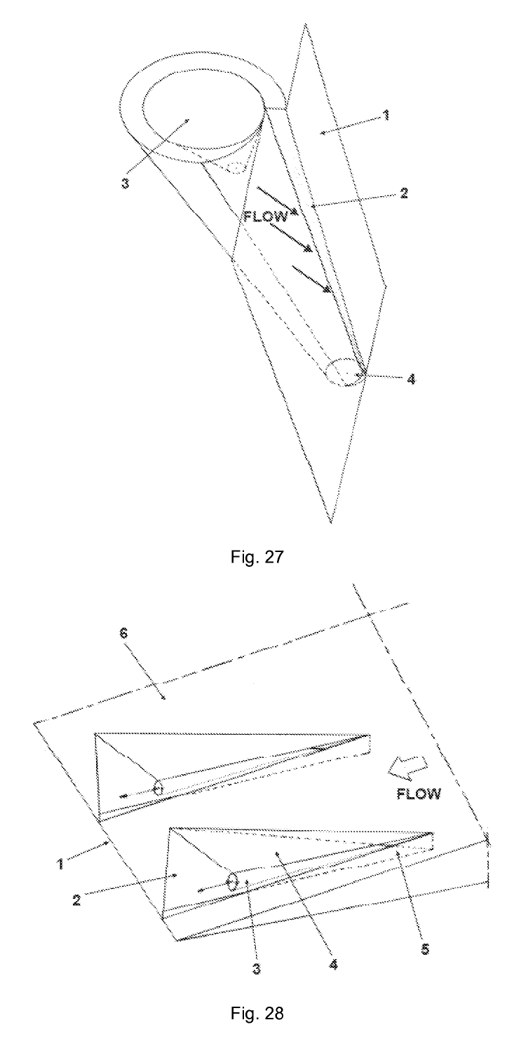

The shape or form of each mechanism element, either the vortex generator or the vortex accelerator, can be of different designs and/or configurations. Some options are the following: Trapezoidal or Triangular flaps with their base towards the leading edge of the blade and the protruding short base (trapezoid) or vertex (triangle) towards the trailing blade edge (FIG. 10-14, 19-21), bumped-shaped protrusions with a rear down-sloping surface (FIG. 26), half-span delta wing or triangular shapes with one of their sides attached to the blade surface and their plane at an angle to the blade surface (FIG. 22-23, 25, 28-45), grooves of different sizes and shapes (FIG. 15-18) with their depth height diminishing along the direction away from the leading edge and towards the trailing edge of the blade and their width increasing along the same direction, blade surface cut-outs (similar to grooves) with triangular or trapezoidal shapes, cylindrical or conical vortex chambers (FIG. 27) embedded into the rotor blade and with intake vanes protruding from or flashed with the blade surface. More detailed description of both the vortex generators and the vortex accelerators is provided in the accompanying drawings.

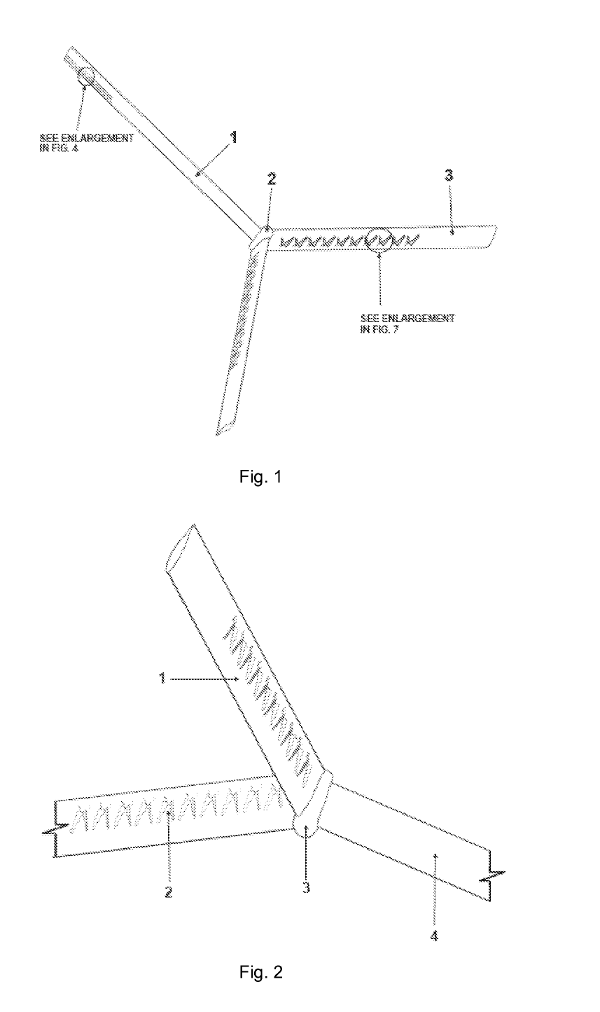

The constituent elements of the vorticity-induced mechanism (vortex generator and vortex accelerator) can be combined in various ways. In some embodiments, vortex generators in the form of triangular flat surfaces or half-span delta wings are combined with wedge-shaped protrusions (FIG. 1-14, 28-40, 42). In other embodiments, both the vortex generator and accelerator are triangular flat surfaces (FIG. 22-23, 25, 28-45). Also we can have rectangular-shaped surfaces or tabs extending out of the blade surface, normal or at an angle to the incoming flow, combined with various types of vortex accelerators. Either the vortex generator or the vortex accelerator or both can extend perpendicularly or at an angle from the blade surface.

Mode 1: A plurality of the fore-mentioned mechanisms, each comprising a vortex generator and a vortex accelerator, are installed on the low pressure or the high pressure or on both sides or surfaces of the airfoil, or they are imbedded inside the blade at the trailing edge region of the airfoil. In the latter case, i.e. when imbedded in the airfoil, the elements (vortex generator and accelerator) can be connected to an electromechanical actuation mechanism to deploy outwards, extending either from the low or the high pressure side or surface of the airfoil. Deploying or extending them downwards, from the high-pressure airfoil surface, results in increasing the generated airfoil lift. Upward deployment, off the low-pressure airfoil surface, results in decreasing the airfoil lift. The passive and/or active outward deployment of the above-mentioned mechanism elements, vortex generator and vortex accelerator, is used to control the circulation around the turbine blade airfoil and hence the generated aerodynamic loading. The reduction of extreme aerodynamic loads at the blade tips during wind gusts or rapidly changing flow speeds, can facilitate the safe use of longer and lighter turbine blades. Longer blades translates to larger rotor swept area and hence higher power output can be achieved based on the wind turbine Pout formula: Pout=Cp*A*V̂3 where: Cp=Pout coefficient, A=Rotor Swept area, V=Wind speed. Also, lighter blades means lower turbine cost since the turbine cost is proportional to the turbine total weight.
Mode 2: The proposed mechanism can be installed on either side or surface of each turbine blade and generate suction in order to transfer momentum to the opposite or the same side or surface of the blade. The transfer of flow momentum can be used to change the aerodynamic characteristics of the blade and hence control the loading or the generated forces. In specific embodiments, mainly used for enhancing the energy capturing capability of the turbine, vortex generators of various forms are arranged in optimal configurations on the high-pressure or impact side of the rotor blades, giving rise to vortices or eddies which are moving along the chord line of the rotor blade or along the direction of the incoming flow (air for wind turbines or water currents for underwater or tidal turbines). Each of these generated vortices, are compressed or their propagation paths are restricted by actively or passively interacting with fins and foils or protrusions or even small contractions or converging nozzles embedded into the rotor blade, which results in accelerating the generated vortices (Vortex Accelerators). The silhouette of the protruding devices or vortex accelerators mentioned above for restricting the propagation path of the vortices, preferably is hidden or covered behind the silhouette of the leading vortex generator, along the path of the incoming flow. The compression of the generated vortices, as their path is restricted by the above-mentioned vortex accelerators, is done in order to accelerate the vortices which results in static pressure drop and hence create suction. The pairing of the vortex generator and the protruding device or vortex accelerator for restricting the path of the generated vortex, is given the name: Vorticity-Induced Pressure Differential Surface Device. A group or pattern of these devices is serially attached along the span on the high-pressure surface of the rotor blade (FIG. 1-9, 41-45). All of these devices can be attached together along a line at a specified distance from the leading edge of the rotor blade or each device can be independently attached at various distances from the leading edge of the rotor blade. For both the turbine (wind or underwater) and the oscillating wing applications, the above-mentioned arrangement of vorticity suction devices on the high-pressure surface of the rotor blade, in some embodiments these devices span part and in other embodiments span the whole length of the rotor blade.

Specifically, in one of the mode 2 embodiments for the wind and underwater turbines, the installation of the vorticity suction devices spans the high-pressure surface of the inner part of the rotor blade attached to the rotor hub, excluding the remaining portion of the blade at the tip (FIG. 1-9). With this arrangement, the drag penalty that corresponds to the vorticity suction devices is minimized, since they are installed on the blade sections of the inner portion of the rotating blade which have lower linear speed compared with the outer blade sections near the blade tip.

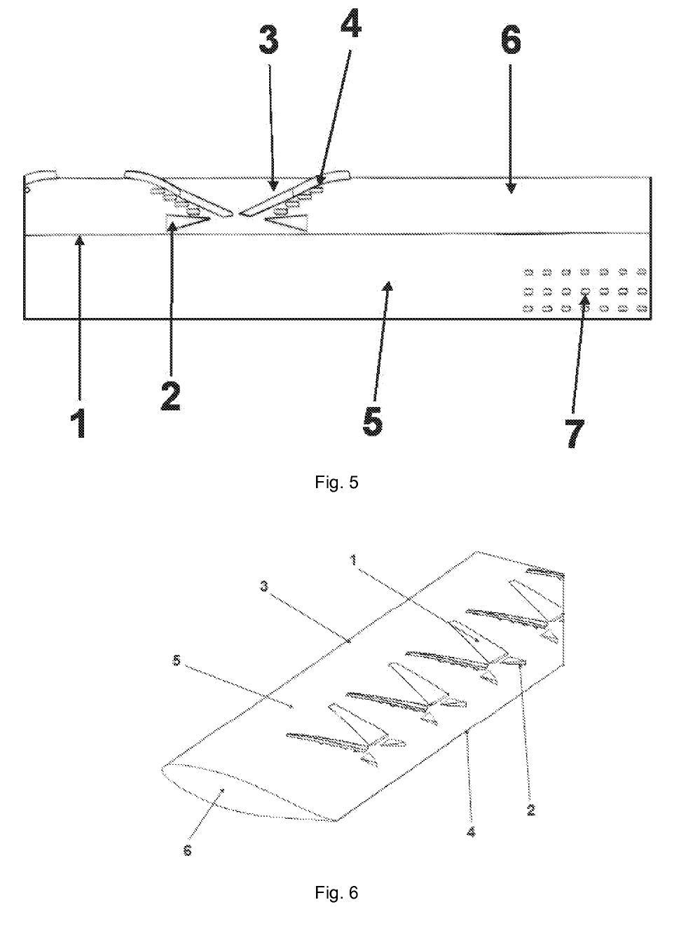

Each Vorticity-Induced Pressure Differential Surface Device described in the previous section, gives rise to suction, which through holes or openings on the blade surface, it transfers momentum to that low-pressure part of the blade where the aerodynamic or hydrodynamic characteristics of the blade are to be enhanced. In a specific mode 2 embodiment of Wind or Underwater turbines, the tip of each blade is the part that is aerodynamically or hydrodynamically enhanced for improved performance, using the above-mentioned suction-induced transfer of momentum (FIG. 1,3-5,8). Given the fact that the incoming flow (either wind or underwater currents) constitutes the Primary Flow, the Suction Flow or Momentum Transfer Flow is the Secondary Flow. The Suction or Secondary Flow is initiated by the vorticity-induced pressure-differential surface devices, through holes/openings on the high pressure surface of the blade (FIG. 5-9) and via conduits inside the blade which ultimately lead to holes/openings on the low-pressure surface of the blade (FIG. 1,3-5,8) where the creation of favourable pressure gradients results in enhancing the aerodynamic/hydrodynamic characteristics of that part of the blade.

In particular embodiments, each Vorticity-Induced Pressure Differential Surface Device, comprises a lid or flap (FIG. 7) that when closed, lies on top of the suction holes and blocks flow through them. It opens due to suction to allow the secondary flow to exit the conduit inside the blade. Also the conduit inside the blade comprises valves that control the air/water flow through them. The operation of these valves is controlled by a feedback control system.

The suction or secondary air/water flow can be used as an Adverse Pressure Gradient suppressor on blades or wings or lifting surfaces used by Air/Water Turbine devices and/or oscillating wing applications. Low pressure generated by the vorticity-induced pressure differential surface device, can be used to achieve any combination of the following:

(1) Suck slow-moving air/water close to the surface or from within the boundary layer on the surface of turbine rotor blades or lifting surfaces.
(2) Suck air/water from the separated air/water flow or the separation bubble on the low-pressure surface of the rotor blades or lifting surfaces of an oscillating wing. Basically, separation bubble is suppressed or diminished in a way that improves the aerodynamic characteristics of the rotor blades.
(3) Reattach separated flow from the rotor blade surface.
(4) Prevent laminar flow from transitioning to turbulent flow.
(5) Suck turbulent flow on the rotor blades and laminarize it.
(6) Control Dynamic Stall on the rotor blades in order to achieve the following:
(6.1) Enhance aerodynamic characteristics when rotor blades not in severe wind gusts.
(6.2) Achieve constant tip speed ratios in rapidly changing wind speed conditions, resulting in longer life for turbine components.
(6.3) In severe gusts, protect the blades from extreme loading in the following ways:
(1) With enhanced aerodynamic characteristics, the blade tips can operate at higher angles of attack, which means they are turned more into the incoming flow than they would normally be. As a result, their profile is exposed less to the incoming gust flow and hence the resulting loading exerted on the blade tips is considerably lower. (2) The suction flow can be reactively shut down, inducing stall on the rotor blades. This way, the lift coefficient when the gust flow hits the blade tip, is lower, which results in giving rise to higher loading forces in the plane of the rotor and not out of the plane of the rotor. Loading generated in the plane of the rotor is less damaging. Hence prevent damaging the blades from excess aerodynamic forces. Shutting down the suction flow will require the use of feedback control system controlling conduit valves.

Suction occurs through hole or slot-perforated blade surface area (FIG. 1,3-5,8-9). The location of the holes or slots on the blade surface is such in order to serve optimally any of the following goals:

(i) When the operation mode of the wind turbine is below the rated wind speed (Wind turbine reaches maximum power output at rated power), operate the wind turbine with its blades at high angles of attack to the relative air flow, where stall occurs, and use the secondary flow to suppress stall in order to keep the flow attached to the surface and as a result achieve Lift Coefficients (CL) higher than normal. Also Drag Coefficients (CD) will be lower, and consequently the Lift-to-Drag (L/D) ratio will increase, effectively improving the output performance of the wind turbine. The suppression of stall mentioned above, requires suction in order to eliminate the reverse flow or the stall bubble on the low-pressure surface of the blade/wing/lifting surface. The stall bubble usually takes place over the three quarter (¾) chord-length area from the trailing edge of the rotor blades/lifting surfaces, but it can also extend beyond this area.
(ii) Use the secondary flow in stall-controlled rotors, when the operation mode of the wind turbine is around rated wind speed or above rated wind speed (rated wind speed is where maximum power output), in order to achieve the following: Make the separated area or the stall bubble on the blades extend in such a way, that the extracted power remains precisely constant, independent of the wind speed, while the power available in the wind at cut-out (Operation stops) exceeds the maximum power output of the turbine by a certain factor. Currently for commercially available, utility size wind turbines, this factor has an optimum value between 8 and 10. In order to achieve the above, a feedback control system will have to be used to adjust the flow rate of the secondary/suction flow continuously. Again, the separated area extends from the trailing edge towards the leading edge of the blade/wing/lifting surface of the wind/air turbine.
(iii) Apply Laminar Flow Control (LFC) or Hybrid Laminar Flow Control (HLFC) in order to minimize skin-friction and pressure drag of the rotating/moving wind turbine blades/lifting surfaces. Basically, use the generated secondary/suction flow in order to keep the flow over the blade/wing/lifting surface laminar and delay transition to turbulence. The Laminarization of the flow results in lower overall drag and smooth and attached air flow at any angle of attack, which effectively gives higher Lift and lower Drag. This requires suction of the slow-moving air close to the surface (Within the Boundary Layer), and it usually needs to occur over one third (⅓) of the chord-length from the leading edge of the wing/blade.

The Vortex Dynamics Turbine described above, may provide the following solutions to corresponding issues and may introduce one or all of the benefits described below:

(1) Increase the efficiency of wind turbines by improving their energy-capturing potential. Hence expand the geography where they can be used by making them economically viable for use in low-wind areas.
(2) Increase the specific rating of wind turbines. This means operate a wind turbine at low-winds with a bigger and heavier generator than a current technology wind turbine. Currently, wind turbines that operate in low winds, use smaller and lighter generators or use bigger and heavier generators at lower efficiencies.
(3) Expand the range of wind speeds where wind turbines can operate at high efficiencies.
(4) Increase the energy-capturing potential of wind turbines at low-wind areas in such a way that will make the use of these turbines in these areas, economically viable with limited increase in the rotor diameter and/or the tower height. Both longer rotor diameter and higher towers exponentially increase the turbine weight which directly increases the turbine cost. As a result, the proposed invention will limit or decrease the cost of using such turbines in low-wind areas.
(5) Prevent or alleviate the loss of Power Output due to the following:
(A) Dynamic stall in turbulent air conditions.
(B) Excessive aerodynamic loads in wind gusts or turbulence.
(C) Turbulent flow over the blades due to dust and dirt on the blade surface.
   (6) Control or alleviate extreme aerodynamic/hydrodynamic loads on turbine blades so that longer and lighter blades can safely be used. Longer blades means more power output and lighter blades translates to lower cost.
   (7) Make the use of underwater turbines for power generation economically viable by increasing their output performance and also their efficiencies.
   (8) Lower the cut-in wind/water speed by increasing the L/D ratio for both wind and underwater turbines.
   (9) Reduce the emitted noise from the wind turbines, by reducing the generated wake behind the fast-moving rotor blade tips.
   (10) Prevent stall of underwater turbines during changing underwater or tidal currents.
   (11) Make oscillating wings efficient enough, so that they can be used for power generation by extracting energy from wind and underwater currents or tides.

As described earlier, in some embodiments of the proposed mechanism, vorticity-induced suction devices or pressure differential devices, are installed on the high pressure surface of the blade. These devices induce suction, which through holes on the high pressure blade surface that connect to a fluid conduit inside the blade and ultimately through holes on the low pressure blade surface at the tip, transfer momentum to the flow over the low pressure surface at the blade tip. This momentum transfer can be used to enhance the aerodynamic characteristics of the blade at the tip or dampen extreme loading on the blade due to turbulence (FIG. 1-9).

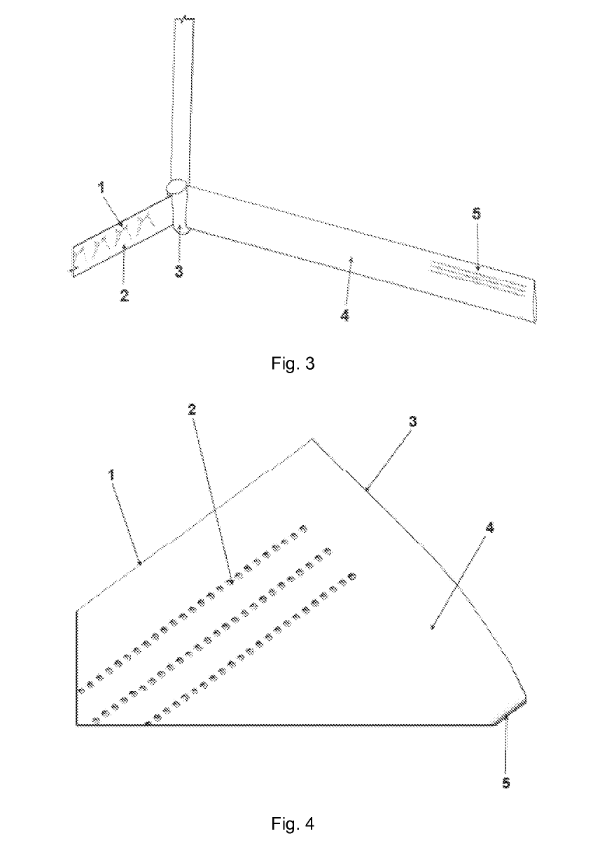

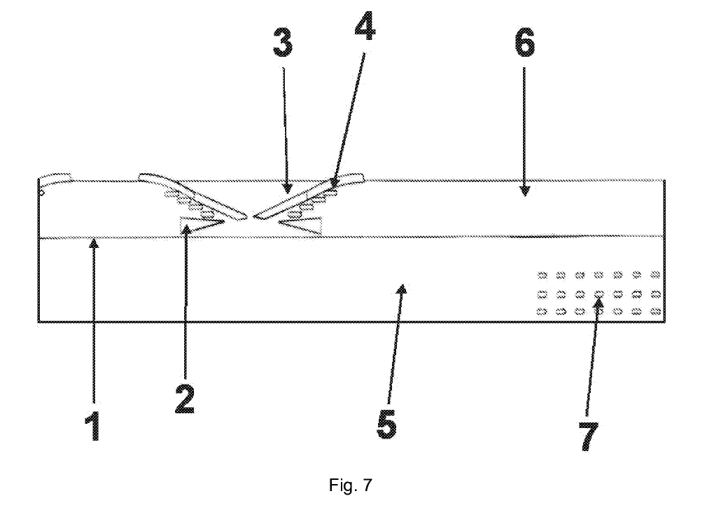

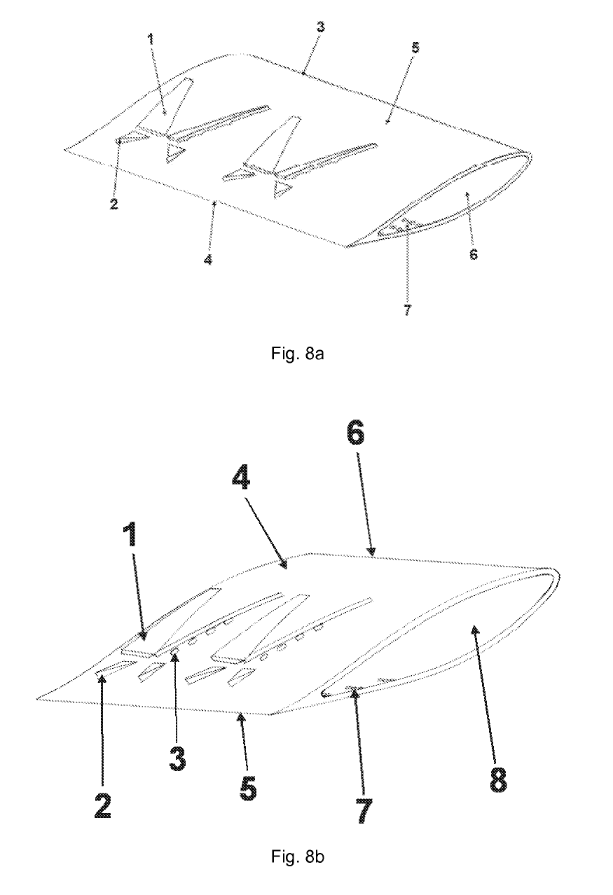

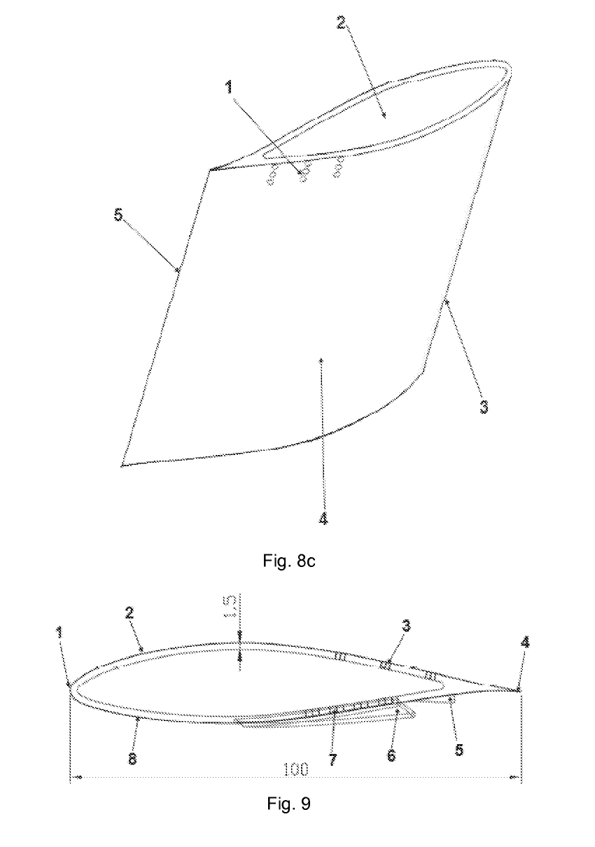

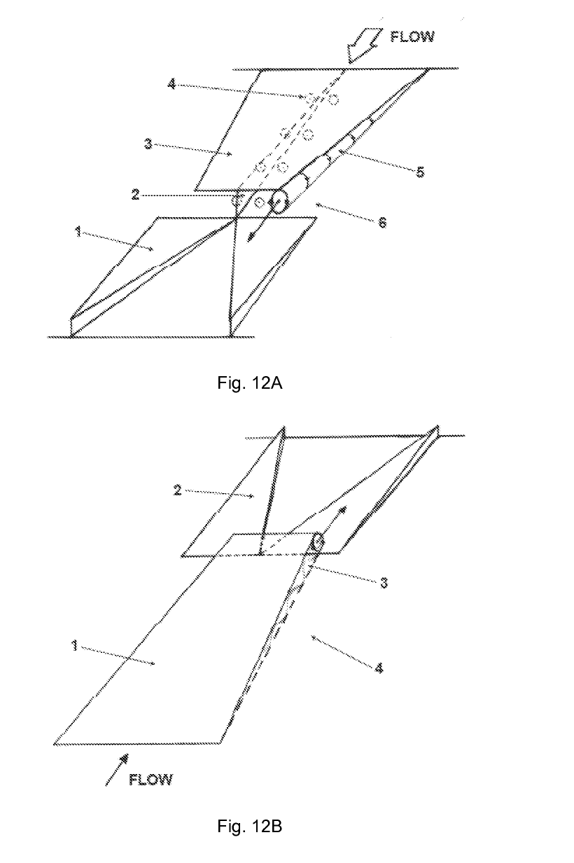

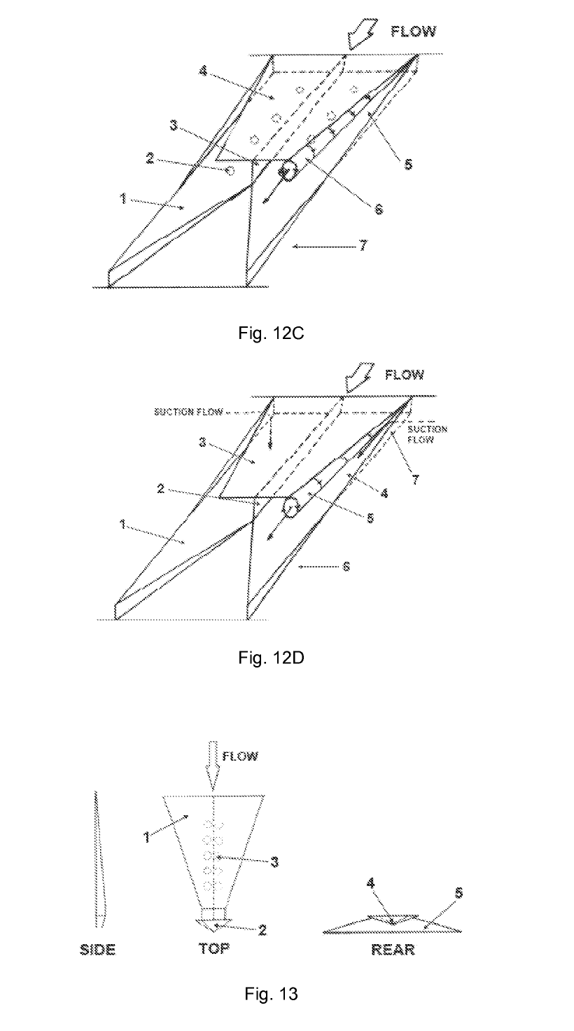

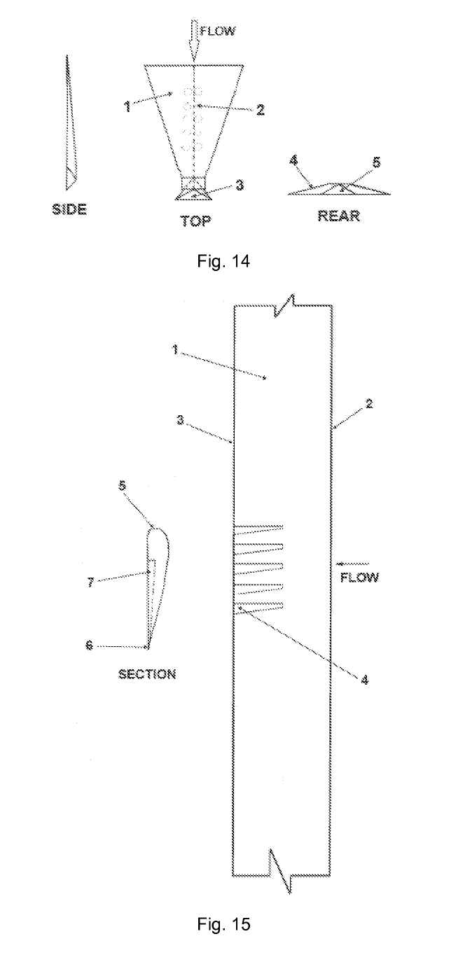

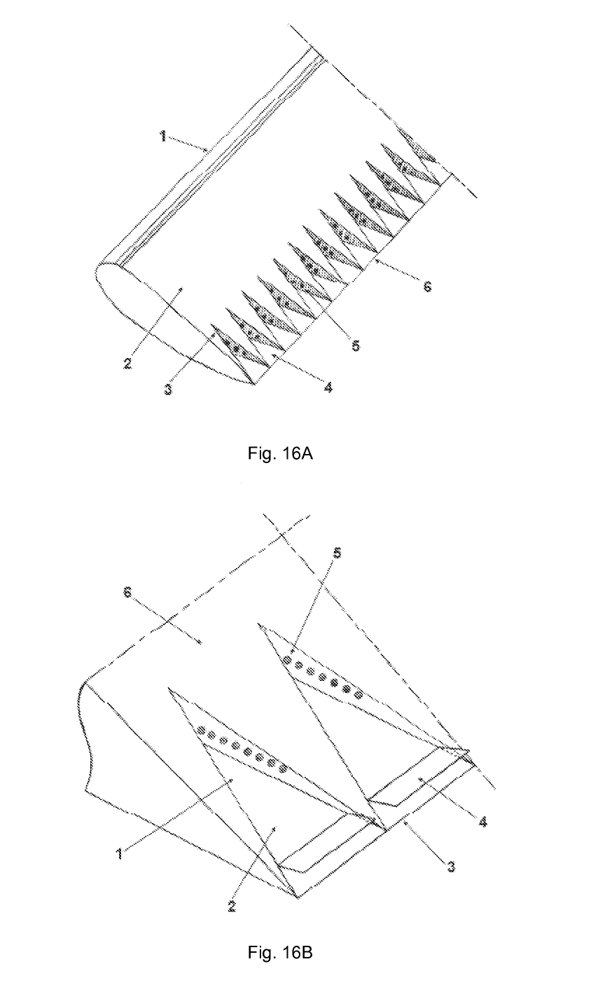

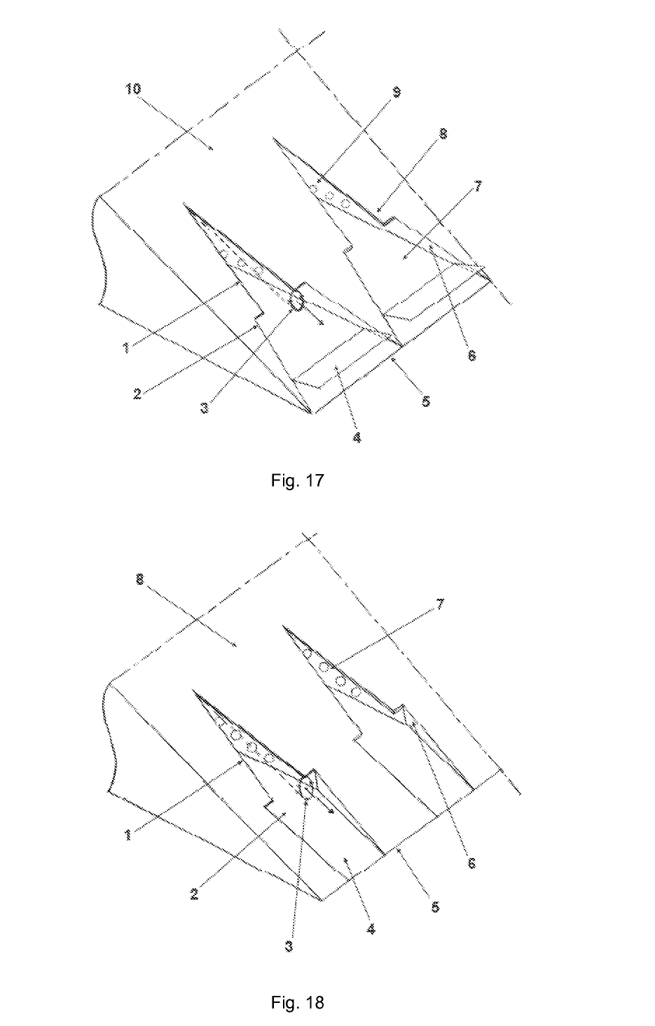

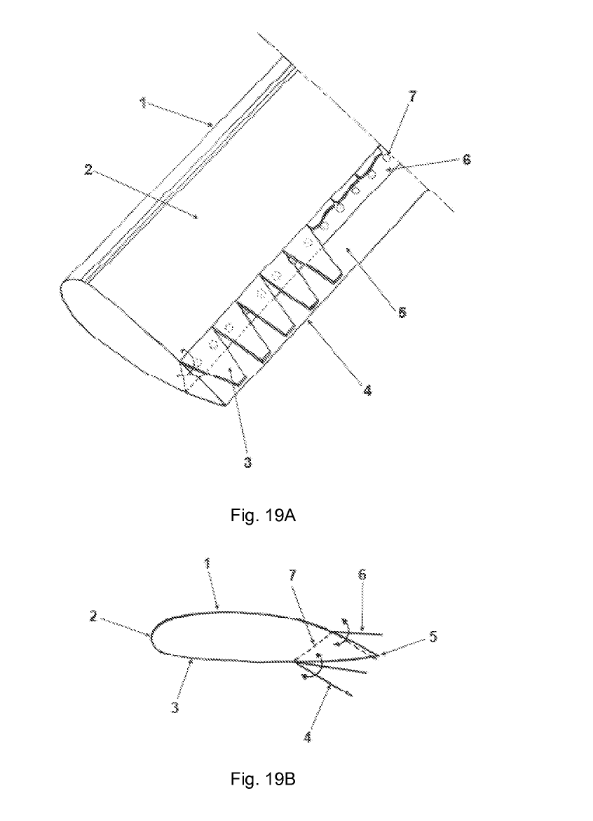

The vorticity mechanism described above, operating in either mode 1 or mode 2 or both, is illustrated through a series of variants or embodiments shown in the accompanied drawings. Many more configurations and variants of the proposed mechanism can be used, beyond those disclosed in the drawings, as long as they adhere to the fundamental principles of operation of the proposed mechanism disclosed in this description.
FIG. 1: Three bladed turbine with variant 1 of vorticity-induced suction devices on the high-pressure surface of the blades and suction openings on the low-pressure surface at the tip of the blades.
   Part terminology: Low pressure surface of a turbine blade (1), Hub of the turbine (2), High pressure surface of a turbine blade (3).
FIG. 2: Three bladed turbine with variant 1 of vorticity-induced suction devices on the high-pressure surface of the blades.
   Part terminology: High pressure surface of a turbine blade (1), Variant 1 of vorticity-induced pressure differential devices (2), Hub of the turbine (3), Low pressure surface of a turbine blade (4).
FIG. 3: Rear view of a three bladed turbine with variant 1 of vorticity-induced suction devices on the high-pressure surface of the blades, and suction holes on the low pressure surface of the blades at the tip.
   Part terminology: Variant 1 of vorticity-induced pressure differential devices (1), High pressure surface of a turbine blade (2), Hub of the turbine (3), Low pressure surface of a turbine blade (4), Suction holes/openings on the low pressure surface at the tip of the blade (5).
FIG. 4: Close-up view of the low pressure surface at the tip of a turbine blade, fitted with suction holes or openings.
   Part terminology: Blade trailing edge (1), Suction holes or openings (2), Tip edge of turbine blade (3), Low pressure surface of turbine blade (4), Blade leading edge (5).
FIG. 5: Close-up view from the rear of a turbine blade section, directly behind the blade trailing edge.
   Part terminology: Blade trailing edge (1), Vortex accelerator protrusion (2), Vortex generator in the form of a blade skin protrusion (3), Suction holes of the variant 1 vorticity-induced suction device (4), Low pressure surface of the turbine blade (5), High pressure surface of the blade (6), Suction holes or openings at the tip of the turbine blade (7).
FIG. 6: Close-up view of a section of a turbine blade close to its base where it attaches to the hub of the turbine.
   Part terminology: Vortex generator in the form of a blade skin protrusion (1), Vortex accelerator wedge protrusion (2), Blade leading edge (3), Blade trailing edge (4), High pressure surface of the turbine blade (5), Blade edge that attaches to the rotor hub (6).
FIG. 7: Close-up view of a section of the high pressure surface of a turbine blade, fitted with variant 1 of vorticity-induced suction devices.
   Part terminology: Vortex generator in the form of a blade skin protrusion (1), Vortex accelerator wedge protrusion (2), Blade leading edge (3), Suction holes (4), Blade trailing edge (5), Eye lid flap for controlling suction flow (6).
FIG. 8A: Schematic view of a section of a turbine blade, which shows two pairs of vorticity-induced suction devices on the high pressure surface and an inside view of the low pressure surface of the blade fitted with suction holes.
   Part terminology: Vortex generator in the form of a blade skin protrusion (1), Vortex accelerator wedge protrusion (2), Blade leading edge (3), Blade trailing edge (4), High pressure blade surface (5), Inside view of the low pressure surface of the blade (6), Suction holes (7).
FIG. 8B: Schematic view of a section of a turbine blade, which shows two pairs of vorticity-induced suction devices on the high pressure surface and an inside view of the low pressure surface of the blade fitted with suction holes.
   Part terminology: Vortex generator in the form of a blade skin protrusion (1), Vortex accelerator wedge protrusion (2), Suction hole (3), High pressure blade surface (4), Blade trailing edge (5), Blade leading edge (6), Suction holes (7), Inside view of the low pressure surface of the blade (8).
FIG. 8C: Schematic view of a section of a turbine blade, showing the low pressure surface of the blade fitted with suction holes.
   Part terminology: Suction holes (1), Inside view of the high pressure blade surface (2), Blade leading edge (3), Low pressure blade surface (4), Blade trailing edge (5).
FIG. 9: Cross section view of a turbine blade fitted with the vorticity-induced suction devices and the suction holes on the low pressure surface at the tip.
   Part terminology: Blade leading edge (1), Low pressure blade surface (2), Suction holes or openings (3), Blade trailing edge (4), Vortex accelerator (5), Vortex generator (6), Suction holes (7), High pressure blade surface (8).
FIG. 10: Variant 2 of Vorticity-Induced Pressure Differential Surface Device.
   Form: A trapezoidal blade skin protrusion with swept-backward triangular surfaces as its vortex accelerator.
   Part terminology: Vortex Generator inclined surface (1), High pressure blade surface (2), Vortex Accelerator (3).
   Description: The Vortex Generator is a trapezoidal cut-out of the blade skin with the height of its protrusion gradually increasing from being flashed with the blade surface upstream to its maximum value where it levels off downstream. Upstream is close to the leading edge (LE) of the blade and downstream towards the trailing edge (TE) of the blade. Each long edge of this protrusion makes an acute angle (e.g. 10.0°-18.0°) with the cord-line of the corresponding blade section. Below or inside this trapezoidal blade skin protrusion, there are suction holes or openings. The Vortex Accelerator consists of triangular swept-back surfaces obstructing the vortex path, generated along the long edges of the trapezoidal vortex generator.
FIG. 11: Top, Side and Rear view diagrams of the variant 2 vorticity-induced suction device shown in FIG. 10.
FIG. 12A/B: Variant 3 of Vorticity-Induced Pressure Differential Surface Device.
   Form: A trapezoidal blade skin extrusion with two downstream up-sloping triangular surfaces as its vortex accelerators.
   Part terminology A: Vortex Accelerator (1), Support wall (2), Vortex Generator (3), Suction holes on the blade surface under the vortex generator (4), Vortex Flow (5), Blade surface (6).
   Part terminology B: Vortex Generator (1), Vortex Accelerator (2), Vortex Flow (3), Blade surface (4).
   Description: The Vortex Generator is a trapezoidal cut-out of the blade skin, up-sloping downstream. Under this vortex generator, there are suction holes or slots on the blade surface. The two vortices generated along the side edges of the vortex generator, are intercepted by two vortex accelerators. These vortex accelerators are triangular surfaces up-sloping downstream.
FIG. 12C/D: Variant 3 of Vorticity-Induced Pressure Differential Surface Device with a groove.
   Form: A trapezoidal blade skin extrusion with a groove underneath and two downstream up-sloping triangular surfaces as its vortex accelerators.
   Part terminology C: Vortex Accelerator (1), Suction hole (2), Support Wall (3), Vortex Generator (4), Groove (5), Vortex Flow (6), Blade surface (7).
   Part terminology D: Vortex Accelerator (1), Support Wall (2), Vortex Generator (3), Groove (4), Vortex Flow (5), Blade surface (6), Suction Slot on the side wall of the groove (7).
   Description: The Vortex Generator is a trapezoidal cut-out of the blade skin, up-sloping downstream. Under this vortex generator, there are suction holes or slots on the blade surface. The two vortices generated along the side edges of the vortex generator, are intercepted by two vortex accelerators. These vortex accelerators are triangular surfaces up-sloping downstream.
FIG. 13: Variant 4 of Vorticity-Induced Pressure Differential Surface Device.
   Form: A trapezoidal blade skin protrusion with an inclined, down-sloping triangular surface as its vortex accelerator.
   Part terminology: Vortex Generator inclined surface (1), Vortex Accelerator (2), Suction holes on the blade surface under the vortex generator (3), Vortex Accelerator (4), Vortex Generator trapezoidal surface (5).
   Description: The Vortex Generator is a trapezoidal cut-out of the blade skin with the height of its protrusion gradually increasing from being flashed with the blade surface upstream, to its maximum value where it levels off downstream. Upstream is close to the leading edge (LE) of the blade and downstream towards the trailing edge (TE) of the blade. Each long edge of this protrusion makes an acute angle (e.g. 10.0°-18.0°) with the cord-line of the corresponding blade section. Below or inside this trapezoidal blade skin protrusion, there are suction holes or openings. The Vortex Accelerator is a down-sloping triangular surface with its base joined to the vortex generator's leveled surface.
FIG. 14: Variant 5 Vorticity-Induced Pressure Differential Surface Device.
   Form: A trapezoidal blade skin protrusion with a bumped vortex accelerator protrusion in the form of a pyramid.
   Part terminology: Vortex Generator inclined surface (1), Suction holes on the blade surface under the vortex generator (2), Vortex Accelerator (3), Vortex Generator inclined surface (4), Vortex Accelerator protrusion (5).
   Description: The Vortex Generator is a trapezoidal cut-out of the blade skin with the height of its protrusion gradually increasing from being flashed with the blade surface upstream to its maximum value where it levels off downstream. Each long edge of this protrusion makes an acute angle (e.g. 10.0°-18.0°) with the cord-line of the corresponding blade section. Below or inside this trapezoidal blade skin protrusion, there are suction holes or openings. The Vortex Accelerator is optimally positioned under the leveled surface of the Vortex Generator, in a way that restricts the propagation path and hence accelerates the generated pair of vortices along each of the two long edges of the vortex generator protrusion. The Vortex Accelerator is basically a bumped or pyramidal protrusion.
FIG. 15: Cord-wise Grooves or Surface Slots as variant 6 of Vorticity-Induced Pressure Differential Surface Devices.
   Form: Grooves with their width linearly increasing along the cord line of the blade, starting from the leading edge (LE) and towards the trailing edge (TE) of the blade.
   Part terminology: High pressure blade surface (1), Leading blade edge (2), Trailing blade edge (3), Vortex Generator or Groove (4), Blade leading edge (5), Blade trailing edge (6), Groove Vortex generator (7).
   Description: The Vortex Generator is a Groove on the high-pressure surface of the blade. It has either two (2) long edges which make an acute angle (e.g. 10.0°-18.0°) with the cord of the blade, or one of the two long edges is along the cord line and the other one makes an acute angle with it. The vortices are generated along the long edges of the groove as the high pressure flow enters the groove. The groove has a short base or a vertex towards the leading edge (LE) of the blade and a longer base where it flashes out with the blade surface, close or at the trailing edge of the blade. The maximum depth of the groove is at its short base or vertex and it decreases gradually towards the long base close to the trailing edge. The diminishing depth of the groove or vortex generator helps accelerate the generated vortices along its long edges.
FIG. 16A/B: Variant 7 of Vorticity-Induced Pressure Differential Surface Device.
   Form: Triangular grooves along the trailing edge of the blade, on its high pressure surface. Suction holes or slots exist on the walls of each groove.
   Part terminology A: Blade Leading Edge (1), High pressure Blade surface (2), Triangular Groove (3), Inside side of Low Pressure blade surface skin (4), Suction or Secondary Flow holes/openings (5), Blade Trailing Edge (6).
   Part terminology B: Triangular Groove (1), Bottom surface of the groove (2), Blade Trailing Edge (3), Vortex Accelerator flap (4), Suction or Secondary Flow holes/openings (5), High pressure blade surface (6).
   Description: Vortices are generated along the long edges of the triangular grooves. These vortices are intercepted by vortex accelerators in the form of flaps, or the inside surface of the low pressure blade skin. The low pressure created, drives the suction flow through the suction holes/slots on the groove walls.
FIG. 17: Variant 8 of Vorticity-Induced Pressure Differential Surface Device.
   Form: Triangular grooves along the trailing edge of the blade, on its high pressure surface. Each of their long edges has a step which divides the groove to front and rear part. Suction holes or slots exist on the side walls of each groove.
   Part terminology: Groove edge step (1), Rear part of the groove (2), Vortex flow (3), Vortex accelerator flap (4), Blade trailing edge (5), Side wall of the groove (6), Bottom surface of the groove (7), Vortex generator edge of the front part of the groove (8), Suction hole (9), High pressure blade surface (10).
   Description: The vortices generated along the front part of the groove edge, are intercepted by vortex accelerator flaps. This creates low pressure which drives the suction flow through the suction holes on the groove side walls.
FIG. 18: Variant 9 of Vorticity-Induced Pressure Differential Surface Device.
   Form: Triangular grooves along the trailing edge of the blade, on its high pressure surface. Each of their long edges has a step which divides the groove to front and rear part. Suction holes or slots exist on the side walls of each groove.
   Part terminology: Vortex generator edge of the front part of the groove (1), Groove (2), Vortex flow (3), Bottom surface of the groove (4), Blade trailing edge (5), Side wall of the groove (6), Suction hole (7), High pressure blade surface (8).
   Description: The vortices generated along the front part of the groove edge, are intercepted by the side walls and the edges of the rear part of the groove. This creates low pressure which drives the suction flow through the suction holes on the groove side walls.
FIG. 19A/B: Variant 10 of Vorticity-Induced Pressure Differential Surface Device.
   Form: Serrated flap along the trailing edge of the high pressure surface of the blade as vortex generator and a regular flap as vortex accelerator along the trailing edge of the low pressure blade surface.
   Part terminology A: Leading edge of the blade (1), High pressure surface of the blade (2), Serrated flap as vortex generator (3), Trailing edge of the blade (4), Flap as vortex accelerator (5), Wall with suction holes (6), Suction hole (7).
   Part terminology B: Low pressure blade surface (1), Leading edge of the blade (2), High pressure surface of the blade (3), Serrated flap as multi vortex generator (4), Trailing edge of blade (5), Vortex Accelerator flap (6), Wall with suction holes (7).
   Description: The vortices generated by the serrated flap attached to the high pressure blade surface, are intercepted by the regular flap attached to the low pressure blade surface. The generation of vortices and their interception gives rise to low pressure in the region between the two above-mentioned flaps. This low pressure is responsible for driving the suction flow through the holes on the blade wall inside this region. This suction flow originates from holes/slots on the low pressure surface of the blade, goes through a conduit system inside the blade and ultimately flows through the suction holes of this vorticity-induced device.

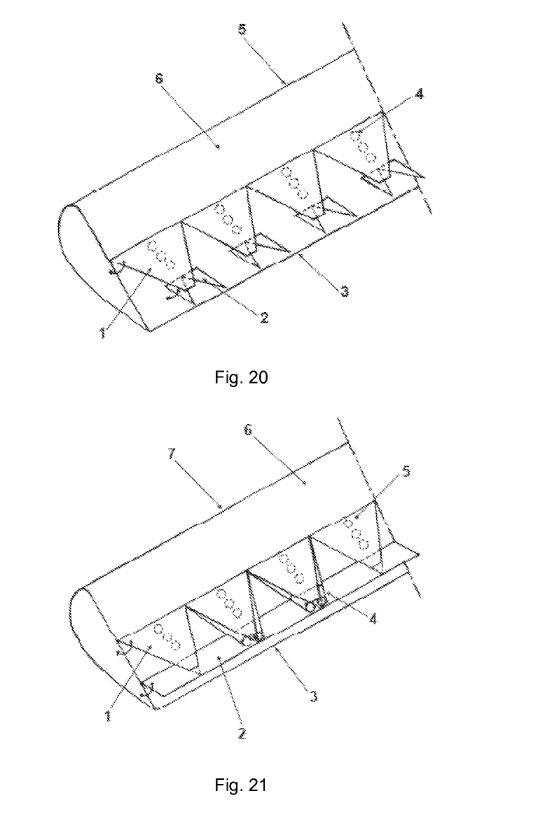

### FIG. 20: Variant 11 of Vorticity-Induced Pressure Differential Surface Device.

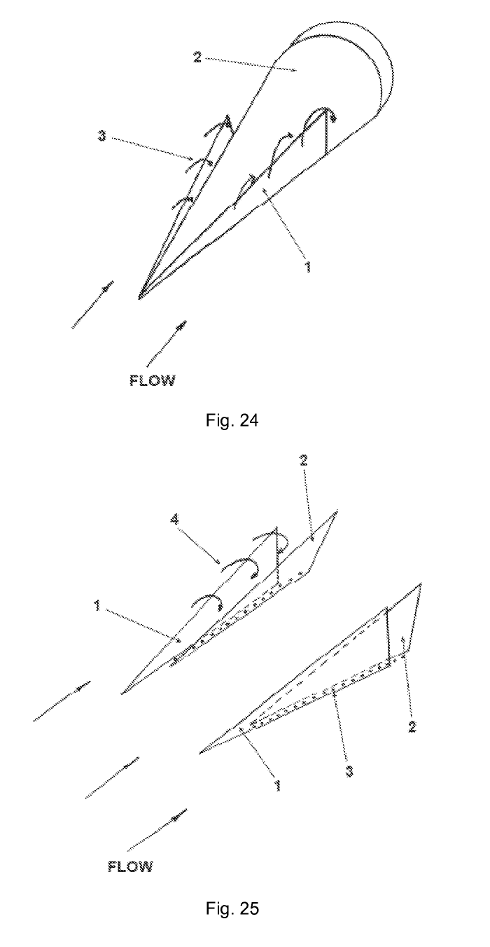

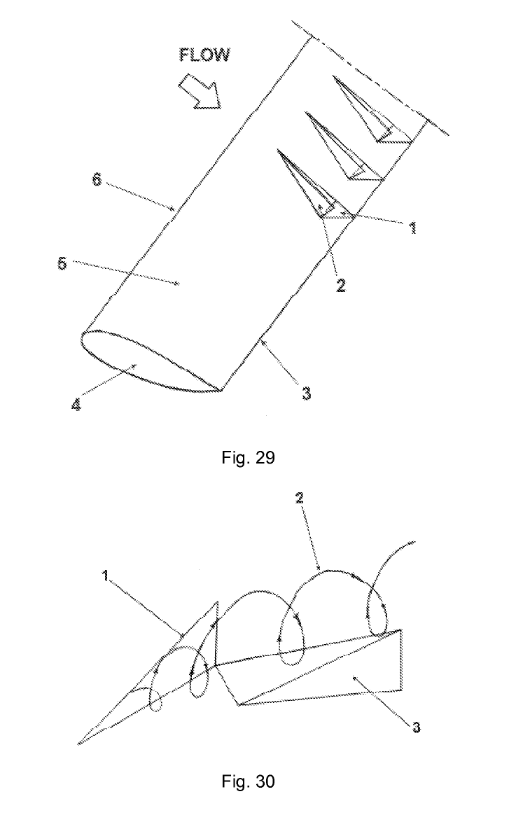

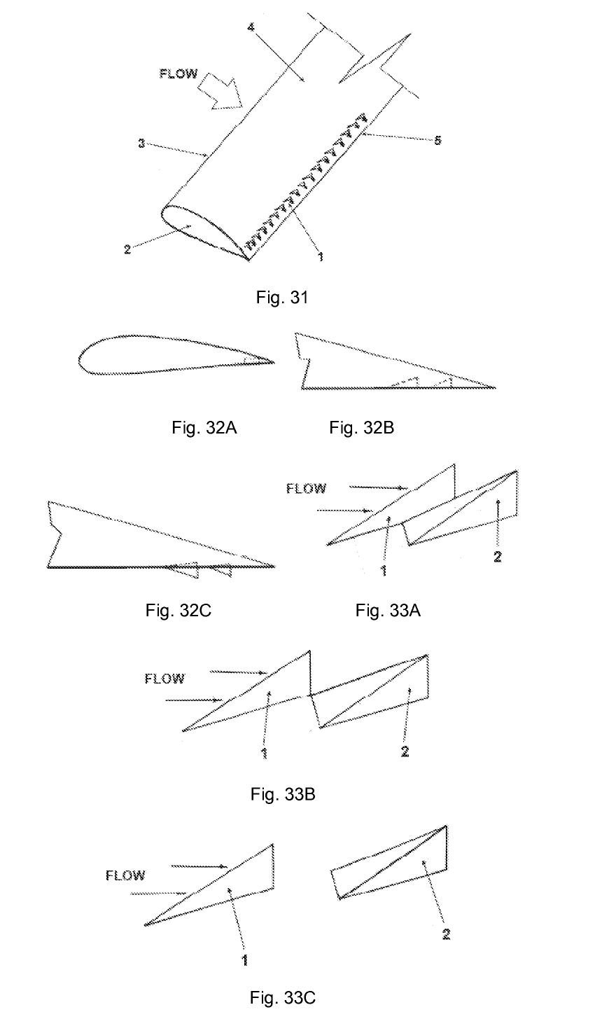

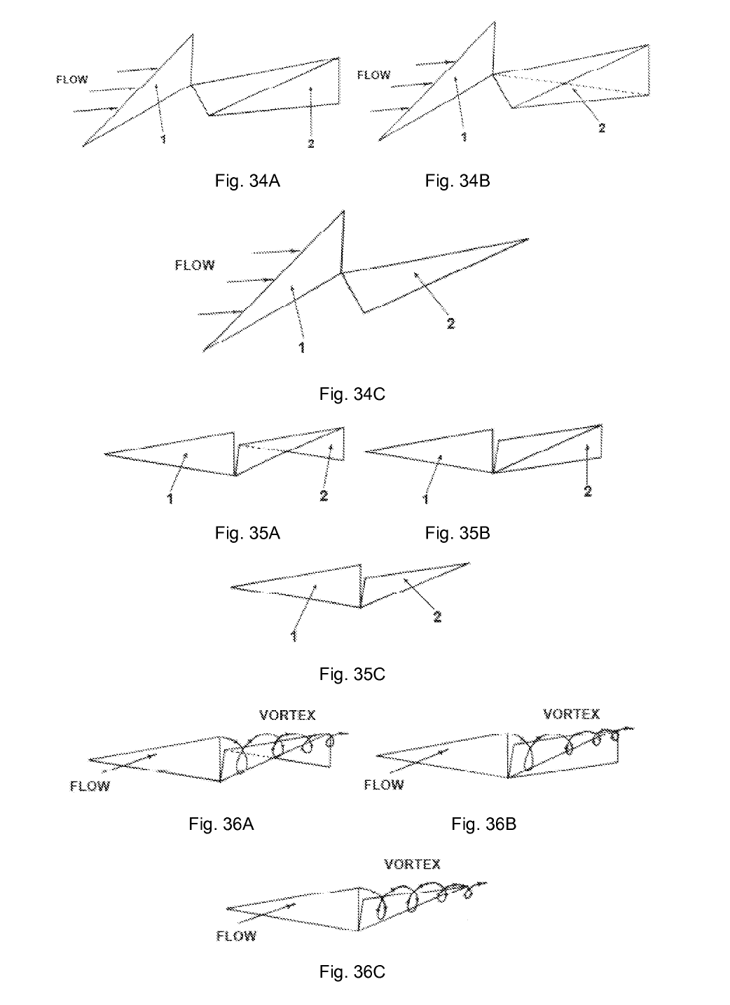

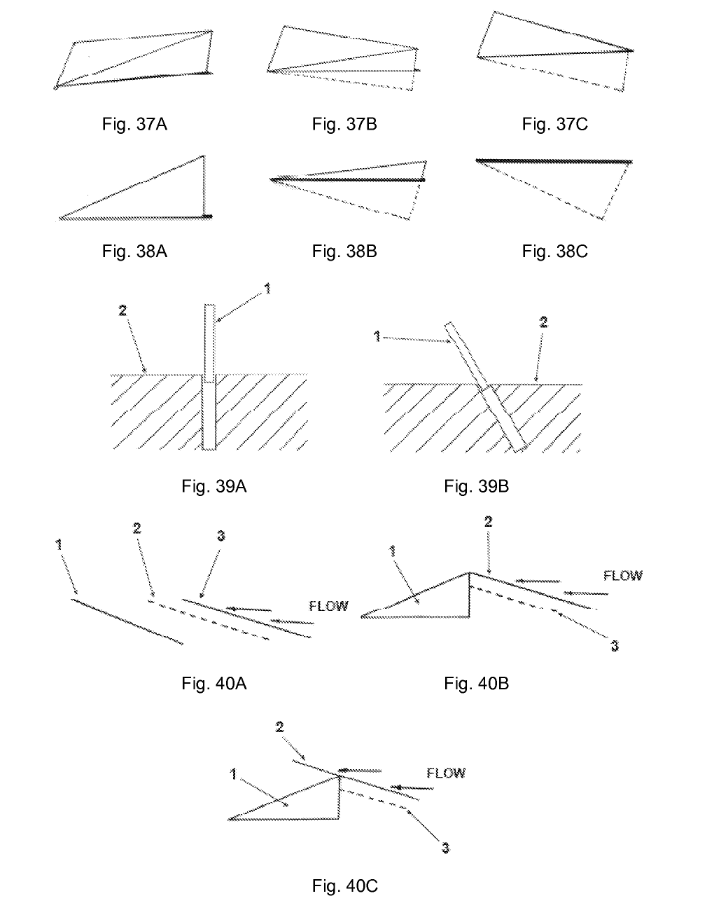

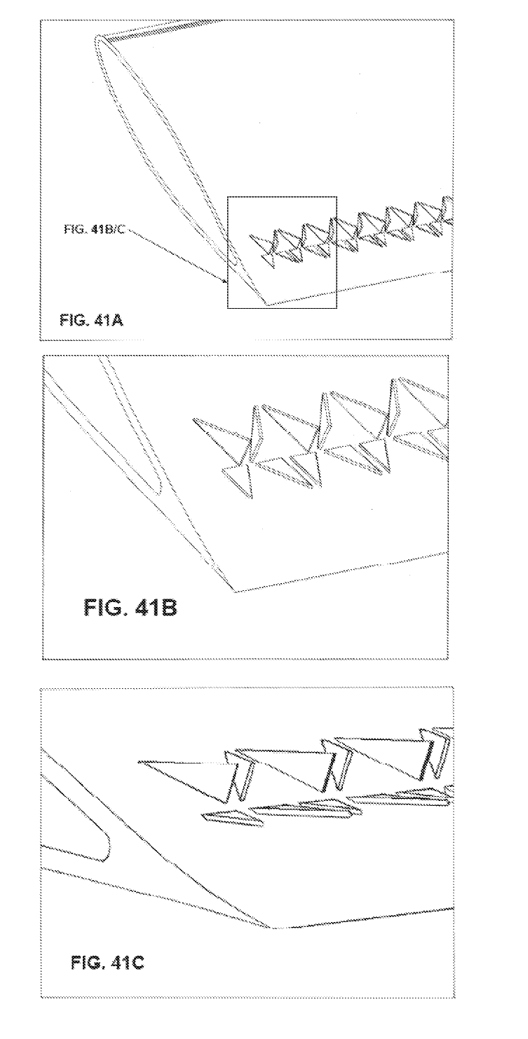

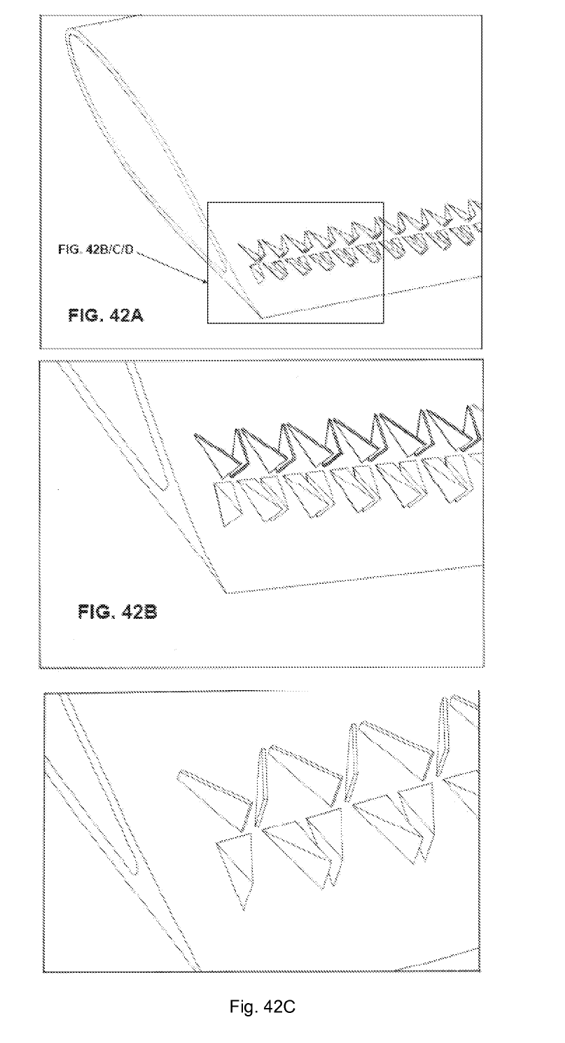

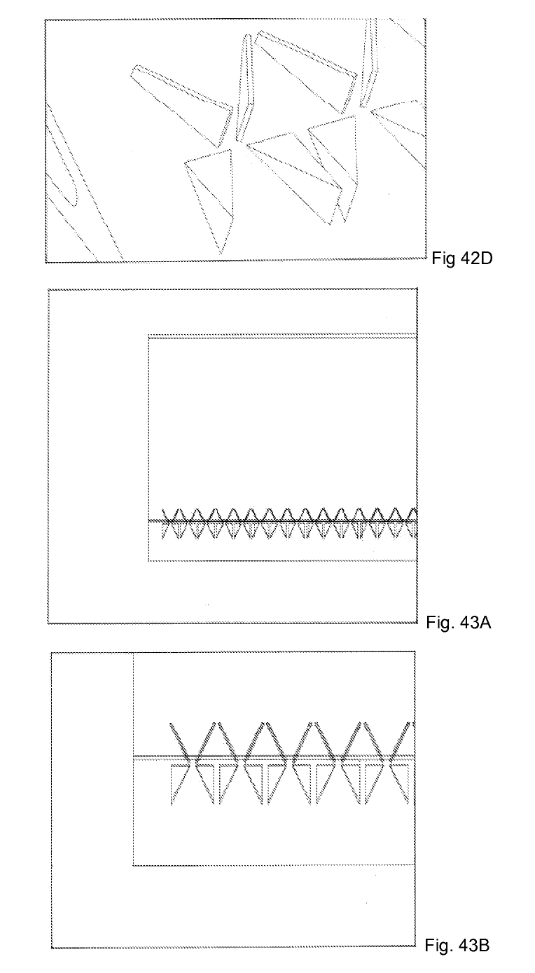

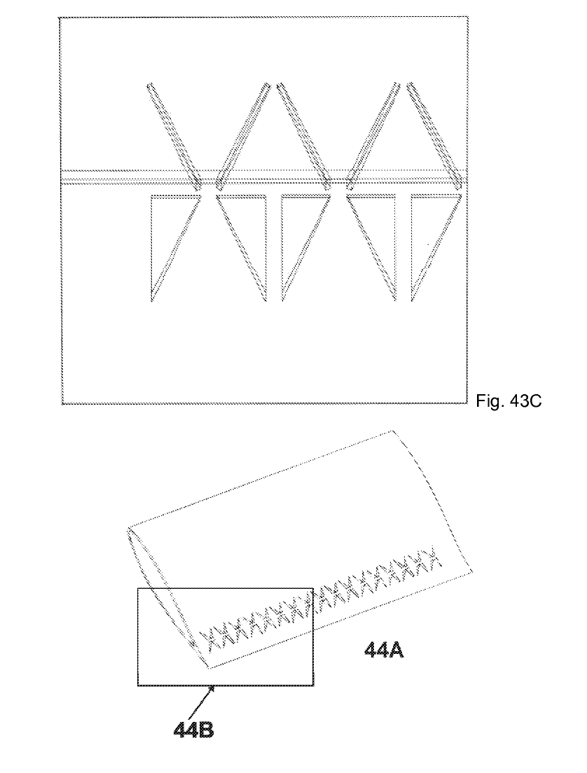

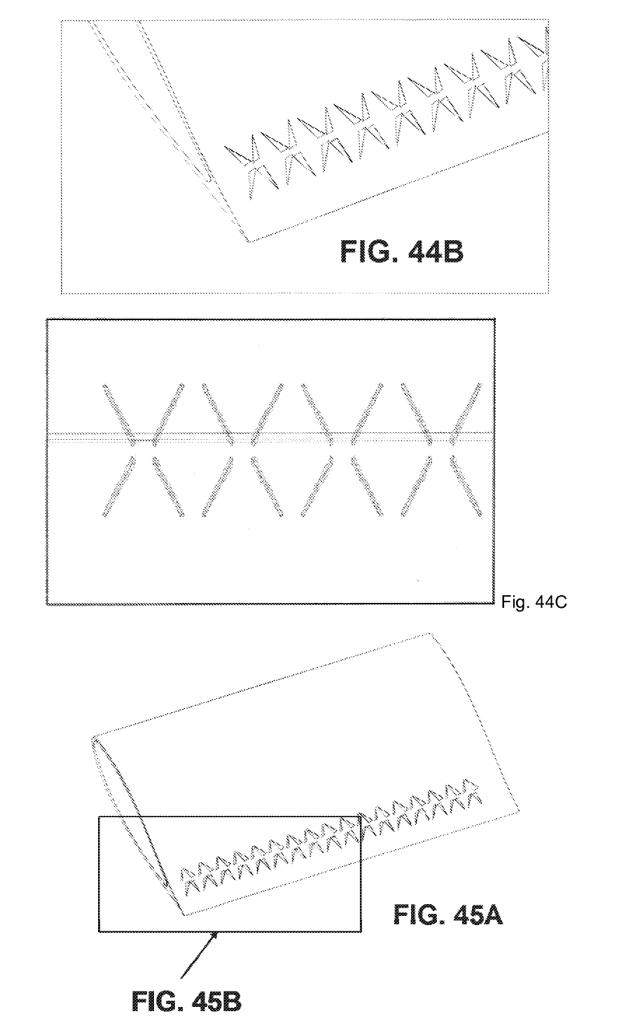

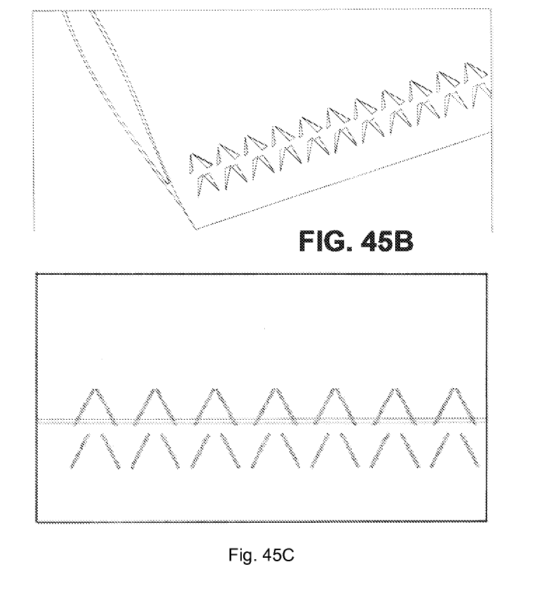

Form: Serrated flap as multi-vortex generator and multiple triangular flaps as vortex accelerators on the high pressure surface of the blade.
Part terminology: Serrated flap as multi-vortex generator (1), Triangular flap as vortex accelerator (2), Trailing edge of the blade (3), Suction hole (4), Leading edge of the blade (5), High pressure surface of the blade (6).
Description: The vortices generated by the serrated flap attached to the high pressure blade surface, are intercepted by multiple triangular flaps downstream. The generation of vortices and their interception gives rise to low pressure in the region underneath the serrated flap where suction holes/slots exist on the high pressure surface of the blade.
FIG. 21: Variant 12 of Vorticity-Induced Pressure Differential Surface Device.
   Form: Serrated flap as multi-vortex generator and a regular flap downstream as a vortex accelerator on the high pressure surface of the blade.
   Part terminology: Serrated flap as multi-vortex generator (1), Regular flap as a vortex accelerator (2), Trailing edge of the blade (3), Vortex (4), Suction hole/slot (5), High pressure surface of the blade (6), Leading edge of the blade (7).
   Description: The vortices generated by the serrated flap attached to the high pressure blade surface, are intercepted by the span wise regular flap downstream. The generation of vortices and their interception gives rise to low pressure in the region underneath the serrated flap where suction holes/slots exist on the high pressure surface of the blade.
FIG. 22A/B/C: Variant 13 of Vorticity-Induced Pressure Differential Surface Device.
   Form: Two (2) triangular surfaces with one of their sides attached to the blade surface. The leading triangular surface is the vortex generator and the one at the back is the vortex accelerator.
   Part terminology: Vortex Generator (1), Vortex Accelerator (2), Suction or Secondary Flow holes/openings (3), Vortex flow (4).
   Description: The Vortex Generator is a triangular surface making an acute angle (e.g. 10.0°-18.0°) with the incoming flow. One of its sides or edges is attached to the blade surface. The plane of this vortex generator can be either perpendicular or at any angle to the blade surface where it is attached. The Vortex Accelerator is also a triangular surface, which makes an angle to the incoming generated vortex flow. It is joined to the blade surface, either with one of its sides or one of its vertices attached to the blade surface. The leading short edge or side of the vortex accelerator can be either aligned or make an offset with the vortex generator as shown in the figure. The plane of the vortex accelerator can be either perpendicular or at any angle to the blade surface where it is attached. Suction holes or openings exist on the blade surface below the generated vortex path and between the edges and/or vertex of the attached triangular surfaces (vortex generator/accelerator).
FIG. 23A/B/C: Variant 14 of Vorticity-Induced Pressure Differential Surface Device.
   Form: A Vortex Generator in the form of a triangular surface attached to the blade surface. A Vortex Accelerator in the form of a triangular surface attached to the vortex generator.
   Part terminology: Vortex Generator (1), Vortex Accelerator (2), Suction or Secondary Flow holes/openings (3), Vortex flow (4).
   Description: The Vortex Generator is a triangular surface making an acute angle (e.g. 10.0°-18.0°) with the incoming flow. One of its sides or edges is attached to the blade surface. The plane of this vortex generator can be either perpendicular or at an angle to the blade surface where it is attached. The Vortex Accelerator is also a triangular surface, attached to the vortex generator at its vertex off the blade surface. The plane of the vortex accelerator down slopes downstream and along the propagation path of the vortex generator. Suction holes or openings exist on the blade surface below the generated vortex flow.
FIG. 24: Variant 15 of Vorticity-Induced Pressure Differential Surface Device.
   Form: A Vortex Generator in the form of two triangular surfaces, making an acute angle between them and attached to the blade surface. A Vortex Accelerator in the form of a half conical body attached with its flat surface to the blade surface.
   Part terminology: Vortex Generator (1), Vortex Accelerator (2), Vortex Flow (3).
   Description: The Vortex Generator is a pair of triangular surfaces making an acute angle (e.g. 10.0°-18.0°) with the incoming flow and between them. Each of these triangular surfaces, has one of its sides or edges attached to the blade surface. The plane of this vortex generator surfaces can be either perpendicular or at any inclination downstream the blade surface where they are attached. The Vortex Accelerator is a half conical surface right behind the pair of the vortex generator triangular surfaces. Suction holes exist on the cone surface right behind the vortex generator triangular surfaces, or/and on the blade surface between the vortex generator and the conical surfaces.
FIG. 25: Variant 16 of Vorticity-Induced Pressure Differential Surface Device.
   Form: A pair of triangular surfaces attached to the blade surface side by side. One of these surfaces is the Vortex Generator and the other one the Vortex Accelerator. Along and between their edges attached to the blade surface, there are secondary flow or suction holes.
   Part terminology: Vortex Generator (1), Vortex Accelerator (2), Suction or Secondary Flow holes/openings (3), Vortex Flow (4).
   Description: The pair of vortex generator and accelerator devices are attached to the blade surface side by side. The vortex generated is squeezed or restricted by the triangular surface of the vortex accelerator. The suction induced by the generated vortex and its capture or control by the vortex accelerator, induces the secondary flow through the suction holes on the blade surface.
FIG. 26: Variant 17 of Vorticity-Induced Pressure Differential Surface Device.
   Form: A Vortex Generator in the form of two triangular surfaces joined at their common edge towards the flow and their longest sides attached to the blade surface. They are swept backwards and making an acute angle between them. The plane of each of these two joined triangular surfaces, is perpendicular or inclined backwards. Behind this vortex generator, a vortex accelerator exists in the form of an asymmetric pyramid-shaped protrusion. Its two frontal surfaces resemble the vortex generator and they are dotted with suction holes.
   Part terminology: Vortex Generator (1), Vortex Accelerator (2), Suction or Secondary Flow holes/openings (3).
   Description: The Vortex Generator consists of two triangular surfaces, joined at their leading edge, swept backwards and making an acute angle between them, and with their longest sides attached to the blade surface. Downstream, behind the vortex generator, a Vortex Accelerator exists in the form of an asymmetric pyramid-shaped protrusion with its two frontal surfaces dotted with suction holes or slots. The space between the vortex generator and the vortex accelerator is optimized so as to maximize the achieved suction through the suction holes.
FIG. 27: Variant 18 of Vorticity-Induced Pressure Differential Surface Device.
   Form: A vortex chamber with its inlet towards the incoming primary flow. Its exhaust nozzle is downstream the flow. A suction port connects the conduit inside the blade with the vortex chamber.
   Part terminology: High pressure blade surface (1), Vortex Chamber Inlet (2), Secondary flow or Suction Inlet port (3), Vortex Chamber exhaust nozzle (4).
   Description: Flow close to the turbine blade surface, enters the vortex chamber through its inlet. The incoming flow is converted to vortex that eventually is discharged through a converging nozzle or conduit. The flow of the generated vortex through the contracting exhaust passage, accelerates the vortex and ultimately induces suction. This suction drives the incoming secondary flow through the suction inlet port.
FIG. 28: Variant 19 of Vorticity-Induced Pressure Differential Surface Device.
   Form: The device is similar to variant 1 shown in FIGS. 1 through 9. In this variant, the vortex generator is a triangular blade surface skin protrusion with a groove underneath. The vortex accelerator is a triangular flap or protrusion downstream the vortex generator.
   Part terminology: Trailing edge of blade (1), Vortex Accelerator (2), Vortex Flow (3), Vortex generator (4), Suction slot on the side wall of the groove (5), High pressure surface of the blade (6).
   Description: Vortex flow generated along the edge of the vortex generator is intercepted by the vortex accelerator protrusion, downstream. The compression of the generated vortex by the vortex accelerator, gives rise to suction that drives the suction flow through the slot on the suction wall.
FIG. 29: Variant 19 of Vorticity-Induced Pressure Differential Surface Device, also shown in close up view in FIG. 28.
   Part terminology: Vortex Accelerator (1), Vortex Generator (2), Trailing edge of the blade (3), Blade tip (4), High pressure surface of the blade (5), Leading edge of the blade (6).
FIG. 30: Variant 20 of Vorticity-induced device, shown with the generated vortex. The vortex generator of the device consists of a half span delta wing or triangular flat surface attached to the surface of a turbine blade. The vortex accelerator, behind the vortex generator, consists of a wedge-shaped protrusion.
   Part terminology: Vortex Generator (1), Vortex (2), Vortex Accelerator (3).
FIG. 31: A series of Variant 20 Vorticity-induced devices attached to the low pressure surface at the trailing edge of a turbine blade.
   Part terminology: Vorticity-induced devices (1), Tip or Root of blade (2), Leading edge of blade (3), Low-pressure side or surface (4), Trailing edge of blade (5).
FIG. 32A: A turbine blade section indicating the part of the blade at the trailing edge where the Variant 20 Vorticity-induced device can be installed.
FIG. 32B: Variant 20 Vorticity-induced device fully retracted in the turbine blade trailing edge.
FIG. 32C: Variant 20 Vorticity-induced device extended from the blade surface at the trailing edge.
FIG. 33A/B/C: Variant 20 Vorticity-induced device in 3 different configurations where the vortex accelerator is installed at 3 different positions or distances from the vortex generator.
   Part terminology: Vortex generator (1), Vortex accelerator (2).
FIG. 34A/B/C: Variant 20 Vorticity-induced device with 3 different versions of its vortex accelerator. In 34A, the vortex accelerator has only 1 triangular surface perpendicular to the blade surface and joined to the its inclined triangular surface. In 34B, the vortex accelerator has 2 triangular surfaces perpendicular to the blade surface, both joined to the inclined surface. In 34C, the vortex accelerator consists only of an inclined triangular surface to the blade surface.
   Part terminology: Vortex generator (1), Vortex accelerator (2).
FIG. 35A/B/C: An alternative side view for the variant 20 Vorticity-induced device configurations shown in FIGS. 34A/B/C.
   Part terminology: Vortex generator (1), Vortex accelerator (2).
FIG. 36A/B/C: Variant 20 Vorticity-induced device configurations shown in previous FIGS. 35A/B/C, depicted with the generated vortex.
FIG. 37 (A) Wedge-shaped vortex accelerator fully extended, (B) Wedge-shaped vortex accelerator half extended, and (C) Wedge-shaped vortex accelerator fully retracted.
FIG. 38 (A) Vortex generator fully extended, (B) Vortex generator half extended, and (C)
   Vortex generator fully retracted.
FIG. 39A: Side view of a fully extended vortex generator perpendicular to the blade surface. Also shown, the retraction groove inside the blade.
   Part terminology: Vortex generator (1), Blade surface (2).
FIG. 39B: Side view of a fully extended vortex generator inclined to the blade surface. Also shown, the retraction groove inside the blade.
   Part terminology: Vortex generator (1), Blade surface (2).
FIG. 40A: Top view of variant 13 Vorticity-induced device, also shown in FIGS. 22A/B/C.
   Part terminology: Vortex generator (1), Suction holes/slots (2), Vortex accelerator (3).
FIG. 40B/C: Top views of 2 configurations for the variant 20 Vorticity-induced device. The devices feature suction holes.
   Part terminology: Vortex generator (1), Vortex accelerator (2), Suction holes/slots (3).
FIG. 41A/B/C: 3-D renderings of variant 20 Vorticity-induced device, also shown in FIG. 34C. This version's vortex accelerator is a triangular surface inclined to the blade surface. This device can be used to either control airfoil circulation or transfer momentum using suction to the surface flow on the blades. Both the vortex generator and the vortex accelerator of the device, can be statically deployed or actively retracted and deployed.
FIG. 42A/B/C/D: 3-D renderings of variant 20 Vorticity-induced device, also shown in FIGS. 30-36. The vortex accelerator of this version has 2 triangular surfaces perpendicular to the blade surface or is a wedged protrusion to the surface. This device can be used to either control airfoil circulation or transfer momentum using suction to the surface flow on the blades. Both the vortex generator and the vortex accelerator of the device, can be statically deployed or actively retracted and deployed.
FIG. 43A/B/C: 2-D top views of variant 20 Vorticity-induced device, shown in FIG. 41-42.
FIG. 44A/B/C: 3-D and 2-D renderings of variant 13 (FIG. 22) Vorticity-induced device in an “X” configuration. This device can be used to either control airfoil circulation or transfer momentum using suction to the surface flow on the blades. Both the vortex generator and the vortex accelerator of the device, can be statically deployed or actively retracted and deployed.
FIG. 45A/B/C: 3-D and 2-D renderings of variant 13 (FIG. 22) Vorticity-induced device in an “Sequential Arrow” configuration. This device can be used to either control airfoil circulation or transfer momentum using suction to the surface flow on the blades. Both the vortex generator and the vortex accelerator of the device, can be statically deployed or actively retracted and deployed.

1. A suction generation device, comprising:
a vortex generator and a vortex accelerator attached together on a surface in an incoming primary flow;
a secondary fluid flow outlet on the surface along the generated vortex path providing, in use, the secondary suction fluid flow.
wherein, in use, fluid flow is created through the secondary fluid flow outlet, due to environmental movement of fluid over the pair of vortex generator and vortex accelerator devices.

2. A suction generation device according to claim 1, further comprising:
a moving flap or a lid, hinged on the surface or wall of the secondary fluid flow outlet, which moves by the pressure differential between the primary fluid/vortex flow and the secondary fluid flow, and in so doing providing the means for regulating the secondary fluid flow through the inlet.

3. A suction generation device according to claim 1, further comprising:
a wall or converging nozzle, upstream the pair of vortex generator and vortex accelerator devices, which compresses the incoming fluid flow.

4. A suction generation device according to claim 1, wherein the suction-generating vorticity is passively controlled.

5. A suction generation device according to claim 1, wherein the suction-generating vorticity is actively controlled.

6. A turbine, comprising:
one or more blades mounted on a hub, the hub being rotatably mounted to rotate together with the blades, a blade having at least one fluid inlet port on the low-pressure surface of the blade; and
a suction device for generating a secondary suction fluid flow from a primary fluid flow, the primary fluid flow being provided by environmental fluid movement;
the at least one fluid inlet port and the suction device being in fluid communication such that, in use, the secondary suction fluid flow is applied to the at least one fluid inlet port of each blade;
wherein, in use, the suction applied to the at least one fluid inlet port modifies the fluid flow over the low pressure surface of the respective blade to improve aerodynamic performance of the blade.

7. A turbine according to claim 1, wherein the primary fluid flow is provided by wind.

8-10. (canceled)

11. A turbine according to claim 1, wherein the passive suction device comprises:
a vortex generator and a vortex accelerator attached together on a surface of the blade in the incoming primary flow;
a secondary fluid flow outlet in the surface along the generated vortex path providing, in use, the secondary suction fluid flow, the secondary fluid flow inlet being in fluid communication with the at least one fluid inlet port of the blades;
a moving flap or a lid, hinged on the surface or wall of the secondary fluid flow outlet, which moves by the pressure differential between the primary fluid/vortex flow and the secondary fluid flow, and in so doing providing the means for regulating the secondary fluid flow through the inlet.

12. A turbine according to claim 6 wherein the vortex generator is a vortex chamber with an inlet in the incoming primary flow and an outlet that leads to another chamber with decreasing cross-sectional area along the chamber-flow propagation path, secondary flow is sucked in the vortex chamber through openings, slots, various types of inlets and converging nozzles.

13. A turbine according to claim 6 wherein the vortex generator comprises:
a panel or flap with an upper and a lower surface, with slots or openings in different shapes, for generating vortex flow structures as fluid flow strikes the panel and goes through the openings, and
a pivotal connecting means for connecting the panel with the vortex generating slots to a span-wise line on the high pressure surface of a lifting surface, including its trailing edge.

14. A turbine according to claim 6 wherein the vortex generator comprises:
a serrated panel or flap with an upper and a lower surface, with a plurality of span-wise, indentions used for generating voracity, and
a pivotal connecting means for connecting the serrated panel to a span-wise line on the high pressure surface of a lifting surface, including its trailing edge.

15. A turbine according to claim 6 wherein the vortex generator is a groove that generates vortices along its long edges.

16. A turbine according to claim 6 wherein the vortex generator is a triangular surface.

17-18. (canceled)

19. A turbine according to claim 6 wherein the vortex accelerator is a triangular surface.

20-21. (canceled)

22. A turbine according to claim 6 wherein:
a plurality of the passive suction devices are attached to the high pressure surface of the blades;
a plurality of suction inlet ports exists on the low pressure side or surface of the blades;
a fluid communication passage between the passive suction devices and the suction inlet ports, is provided by the inside walls of the blades; wherein
converging nozzles are attached on the inside walls of the fluid communication passage with their exhaust cross-sectional area defined by the size of the secondary flow inlet ports to the passive suction devices.

23. A turbine according to claim 6, with active suction devices attached to the high pressure surface of the blades.

24. A turbine according to claim 6 wherein:
a plurality of active suction devices are attached to the low pressure side or surface of the blades;
a plurality of suction inlet ports exists on the high pressure side or surface of the rotating blades;
a fluid communication passage between the passive suction devices and the suction inlet ports, is provided by the inside walls of the blades;
Converging nozzles are attached on the inside walls of the fluid suction passage with their exhaust cross-sectional area defined by the size of the secondary flow inlet ports to the passive suction devices.

25. A turbine according to claim 4-96, with active suction devices attached to the low pressure surface of the blades.

26. A turbine according to claim 6, wherein the application of the suction to the fluid inlet port of the blades is controlled to provide a stall or adverse pressure gradient suppression system.

27-28. (canceled)

29. A method for extracting fluid flow energy and using it to enhance the aerodynamic characteristics of a wing, comprising the steps of:
vortex generation by providing vortex generators on the high-pressure surface of the wing, to intercept the incoming fluid flow;
capturing and accelerating the said generated vortices by means of an active and/or passive control mechanism and converting the vortex flow energy to a low pressure region;
confining the said generated low-pressure inside at least one low-pressure chamber;
providing the necessary fluidic communication between the said low-pressure chamber and a conduit or internal fluidic passage means inside the wing;
sucking flow close to the outer skin surface of said wing through perforated areas;
enhancing the aerodynamic characteristics of said wing by using said generated suction to suppress adverse pressure gradients or boundary layer suction on the outer surface skin of said wings, rotor blades and lifting body surfaces; apply Laminar Flow Control and/or Hybrid Laminar Flow Control; suppress the size of the separated flow bubble on the low-pressure surface or downstream the flow around the said wing; or Control the aerodynamic and/or hydrodynamic loading on the wing or lifting surface.

30-37. (canceled)
